(19) United States
(12) Patent Application Publication
(10) Pub. No.: US 2007/0035488 A1
(43) Pub. Date: Feb. 15, 2007

(54) Driving method of display device

(75) Inventor: Hajime Kimura, Atsugi (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/287,569

(22) Filed: Nov. 23, 2005

(30) Foreign Application Priority Data
Dec. 3, 2004 (JP) 2004-352072

(51) Int. Cl. G09G 3/30

(52) U.S. Cl. 345/77

(57) ABSTRACT

Pseudo contours occur in a display device that expresses a gray scale by dividing one frame into a plurality of subframes and using a time gray scale method. In the case of expressing a high-order bit, a gray scale is expressed by sequentially adding the weight (light emitting period, frequency of light emission, and the like) in each subframe. On the other hand, in the case of expressing a low-order bit, a gray scale is expressed by selecting a subframe where light is emitted. Then, subframes for a high-order bit and subframes for a low-order bit are not to be unevenly distributed in a specific place in one frame.

### TECHNICAL FIELD

The present invention relates to a driving method of a display device, in particular a driving method of a display device adopting a time gray scale method.

### BACKGROUND ART

In recent years, a so-called self-luminous type display device having a pixel that is formed of a light emitting element such as a light emitting diode (LED) has been attracting attention. As a light emitting element used for such a self-luminous type display device, an organic light emitting diode (OLED) (also called an organic EL element, an electro luminescence:EL element, and the like) has been drawing attention and used for an EL display (for example, an organic EL display and the like). Since a light emitting element such as an OLED is a self-luminous type, it has advantages such as higher visibility of pixels than that of a liquid crystal display, and fast response without requiring a backlight. The luminance of a light emitting element is controlled by a current value flowing through it.

As a driving method of controlling a light emitting gray scale of such a display device, there are a digital gray scale method and an analog gray scale method. According to the digital gray scale method, a light emitting element is turned on/off in a digital manner to express a gray scale. Meanwhile, the analog gray scale method includes a method of controlling the light emitting intensity of a light emitting element in an analog manner and a method of controlling the light emitting time of a light emitting element in an analog manner.

In the case of the digital gray scale method, there are only two states: a light emitting state and a non-light emitting state. Therefore, only 2 gray scales can be expressed if nothing is done. Accordingly, another method is used in combination to achieve multiple gray scales. A time gray scale method is often used as a method for multiple gray scales.

As a display for controlling a display state of a pixel in a digital manner and expressing a gray scale in combination with a time gray scale, there are some displays as well as an organic EL display using the digital gray scale method. As an example, there is a plasma display or the like.

The time gray scale method is a method of expressing a gray scale by controlling the length of a light emitting period or the frequency of light emission. That is to say, one frame period is divided into a plurality of subframe periods, each of which is weighted with respect to the frequency of light emission and a light emitting period, and then the total weight (the sum of the frequency of light emission and the sum of the light emitting period) is differentiated for each gray scale, thereby expressing a gray scale. It is known that a defection of display called a pseudo contour (or a fake contour) is caused when such a time gray scale method is used. Therefore, the measure thereof has been studied (see Patent Documents 1 to 7).

[Patent Document 1] Japanese Patent No. 2903984

[Patent Document 2] Japanese Patent No. 3075335

[Patent Document 3] Japanese Patent No. 2639311

[Patent Document 4] Japanese Patent No. 3322809

[Patent Document 5] Japanese Patent Laid-Open No. hei 10-307561

[Patent Document 6] Japanese Patent No. 3585369

[Patent Document 7] Japanese Patent No. 3489884

### DISCLOSURE OF THE INVENTION

### Problems to be Solved by the Invention

Although various methods for reducing pseudo contours are thus suggested, a sufficient effect for reducing pseudo contours has not been obtained yet.

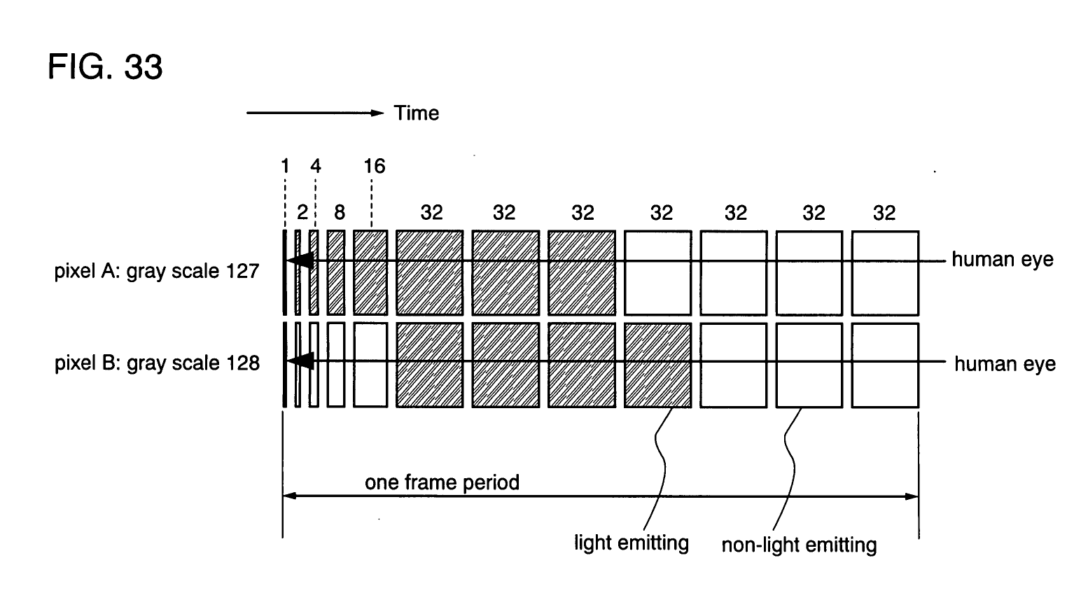

For example, Patent Document 2 is referred, and it is assumed that a gray scale level of 127 is expressed in a pixel A and a gray scale level of 128 is expressed in a pixel B adjacent to the pixel A. A light emitting state and a non-light emitting state in each subframe in this case are shown in FIG. 33. In the case where one sees only the pixel A or the pixel B without turning one's eyes away, a pseudo contour is not caused. This is because the sum is taken with respect to the luminance of the place where one's eyes pass, thereby one's eyes sense the luminance. Therefore, eyes sense the gray scale level of the pixel A to be 127 (=1+2+4+8+16+32+32+32), and eyes sense the gray scale level of the pixel B to be 128 (=32+32+32+32). That is to say, eyes sense an accurate gray scale.

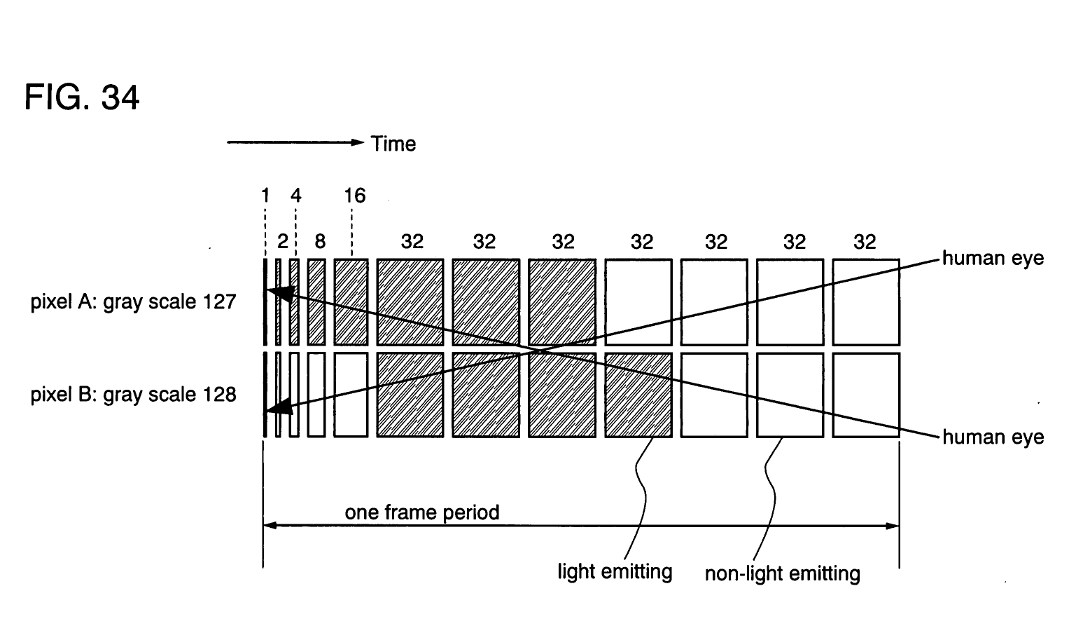

On the other hand, it is assumed that eyes move from the pixel A to the pixel B or from the pixel B to the pixel A. Such a case is shown in FIG. 34. In this case, eyes sometimes sense the gray scale level to be 96 (=32+32+32), and sometimes sense the gray scale level to be 159 (=1+2+4+8+16+32+32+32+32) in accordance with eyes' movement. Although the eyes are expected to sense the gray scale levels to be 127 and 128, they sense the gray scale levels to be 96 to 159. As a result, a pseudo contour is caused.

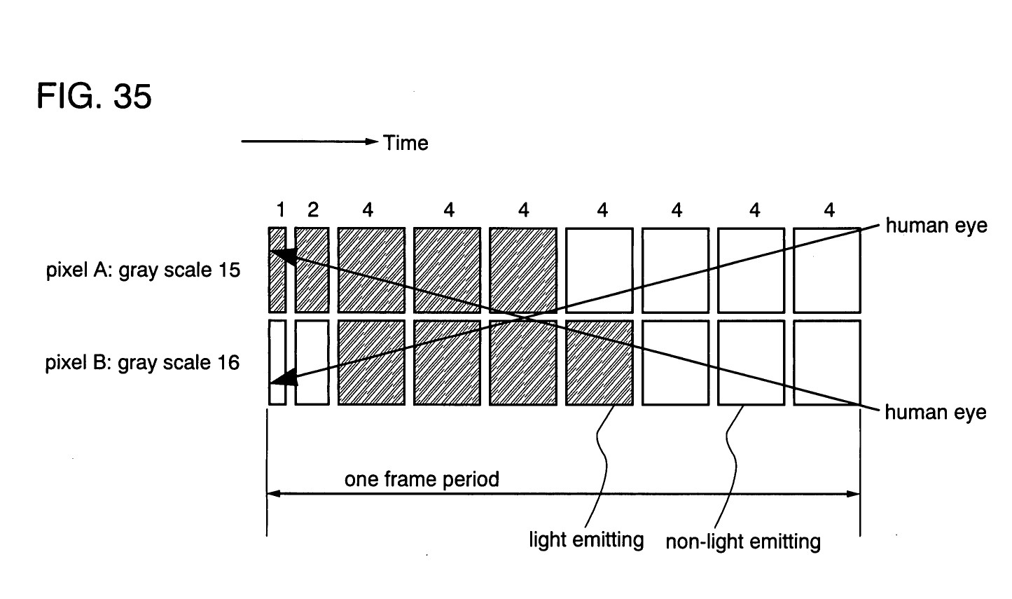

FIGS. 33 and 34 show the case of 8 bits (256 gray scales). Subsequently, FIG. 35 shows a case of 5 bits. In this case also, eyes sometimes sense the gray scale level to be 12 (=4+4+4), and sometimes sense the gray scale level to be 19 (=1+2+4+4+4+4) in accordance with eyes' movement. Although the eyes are expected to sense gray scale levels to be 15 and 16, they sense the gray scale levels to be 12 to 19. As a result, a pseudo contour is caused.

In view of these problems, it is an object of the invention to provide a display device that is constituted by a small number of subframes and can reduce pseudo contours, as well as a driving method using the same.

### MEANS FOR SOLVING THE PROBLEMS

In the invention, in the case of expressing a high-order bit (that is, a high digit bit such as MSB (Most Significant Bit)) of halftone expressed by a binary number, a gray scale is expressed by sequentially adding the weight (light emitting period, frequency of light emission, and the like) in each subframe. On the other hand, in the case of expressing a low-order bit (that is, a low digit bit such as LSB (Least Significant Bit)) of halftone expressed by a binary number, a gray scale is expressed by selecting a subframe where light is emitted. Then, subframes for a high-order bit and subframes for a low-order bit are not to be unevenly distributed in a specific place in one frame. For example, a subframe for a low-order bit is to be sandwiched between subframes for a high-order bit. By expressing a gray scale using such a method, the aforementioned object is achieved.

The invention is a driving method of a display device for expressing a gray scale by dividing one frame into a plurality of subframes, which is characterized in that a plurality of subframes corresponding to a high-order bit of halftone expressed by a binary number are almost equally weighted with respect to light emission, one or more subframes corresponding to a low-order bit of halftone expressed by a binary number are weighted based on a binary number with respect to light emission, light is emitted in one subframe of the plurality of subframes corresponding to the high-order bit in the one frame, light is emitted in one subframe of the one or more subframes corresponding to the low-order bit thereafter, and then light is emitted in another subframe of the plurality of subframes corresponding to the high-order bit.

The invention is a driving method of a display device for expressing a gray scale by dividing one frame into a plurality of subframes, which is characterized in that a plurality of subframes corresponding to a high-order bit of halftone expressed by a binary number are almost equally weighted with respect to light emission, a plurality of subframes corresponding to a low-order bit of halftone expressed by a binary number are weighted based on a binary number with respect to light emission, light is emitted in one subframe of the plurality of subframes corresponding to the low-order bit in the one frame, light is emitted in one subframe of the plurality of subframes corresponding to the high-order bit thereafter, and then light is emitted in another subframe of the plurality of subframes corresponding to the low-order bit.

The invention is a driving method of a display device for expressing a gray scale by dividing one frame into a plurality of subframes, which is characterized in that a plurality of subframes corresponding to a high-order bit of halftone expressed by a binary number are almost equally weighted with respect to light emission, a plurality of subframes corresponding to a low-order bit of halftone expressed by a binary number are weighted based on a binary number with respect to light emission, light is emitted in one subframe of the plurality of subframes corresponding to the low-order bit in the one frame, light is emitted in a plurality of subframes of the plurality of subframes corresponding to the high-order bit thereafter, and then light is emitted in another subframe of the plurality of subframes corresponding to the low-order bit.

The invention is a driving method of a display device for expressing a gray scale by dividing one frame into a plurality of subframes, which is characterized in that a plurality of subframes corresponding to a high-order bit of halftone expressed by a binary number are almost equally weighted with respect to light emission, a plurality of subframes corresponding to a low-order bit of halftone expressed by a binary number are weighted based on a binary number with respect to light emission, light is emitted in one subframe of the plurality of subframes corresponding to the high-order bit in the one frame, light is emitted in a plurality of subframes of the plurality of subframes corresponding to the low-order bit thereafter, and then light is emitted in another subframe of the plurality of subframes corresponding to the high-order bit.

The invention is a driving method of a display device for expressing a gray scale by dividing one frame into a plurality of subframes, which is characterized in that a plurality of subframes corresponding to a high-order bit of halftone expressed by a binary number are almost equally weighted with respect to light emission, a plurality of subframes corresponding to a low-order bit of halftone expressed by a binary number are weighted based on a binary number with respect to light emission, and a plurality of subframes corresponding to either the high-order bit or the low-order bit that has a smaller number of bits are selected through one subframe selected from a plurality of subframes corresponding to either the high-order bit or the low-order bit that has a larger number of bits.

The kind of transistors applicable to the invention is not limited. A thin film transistor (TFT) using a non-single crystalline semiconductor film represented by amorphous silicon or polycrystalline silicon, a MOS transistor formed using a semiconductor substrate or an SOI substrate, a junction transistor, a bipolar transistor, a transistor using an organic semiconductor or a carbon nanotube, and other transistors can be applied. Furthermore, the kind of substrates over which a transistor is arranged is not limited. It can be arranged over a single crystalline substrate, an SOI substrate, a glass substrate, a plastic substrate or the like.

It is to be noted that in the invention, connection means electrical connection. Therefore, in the structures disclosed in the invention, other elements (for example, another element, switch, or the like) enabling electrical connection may be additionally arranged between a predetermined connection relation.

### EFFECT OF THE INVENTION

According to the invention, pseudo contours can be reduced. Thus, display quality is improved and clear images can be seen.

### BEST MODE FOR CARRYING OUT THE INVENTION

Although embodiment modes of the invention are described below with reference to drawings, it is to be understood that various changes and modifications will be apparent to those skilled in the art. Therefore, unless such changes and modifications depart from the scope of the invention, they should be construed as being included therein.

### Embodiment Mode 1

First, a case of expressing a gray scale by 5 bits is considered as an example here. That is, description is made on a case of 32 gray scales. First, gray scales (here, 5 bits) to be expressed are divided into high-order bits and low-order bits, for example, high-order 3 bits and low-order 2 bits here.

In the invention, the high-order 3 bits express a gray scale by sequentially adding a light emitting period (or the frequency of light emission in a certain period) in each subframe. That is, as a gray scale level increases, light is emitted in more subframes. Therefore, in a subframe where light is emitted when a gray scale level is low, light is emitted when a gray scale level is high. Such a gray scale method is referred to as an overlapping time gray scale method.

On the other hand, the low-order 2 bits express a gray scale by selecting a subframe where light is emitted among subframes having different light emitting periods (or frequencies of light emission in a certain period). The length of a light emitting period (or the frequency of light emission in a certain period) in each subframe is, for example, weighted based on a binary number, and is equal to the power of 2. Accordingly, in the case of the power of 2, the light emitting period (or the frequency of light emission in a certain period) in each subframe is 1:2:4:8: . . . . A gray scale is expressed by selecting whether light is emitted in each subframe. Accordingly, in a subframe where light is emitted when a gray scale level is low, light is not always emitted when a gray scale level is high. In this specification, such a gray scale method is referred to as a binary code time gray scale method.

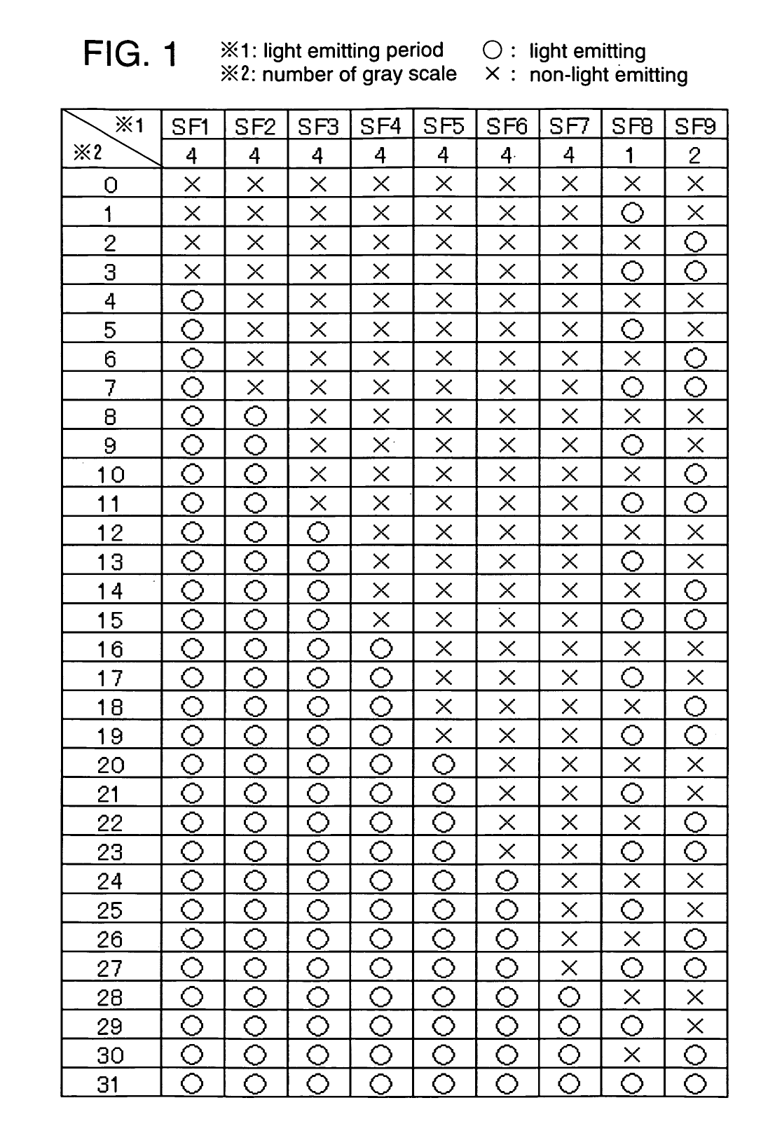

Subsequently, description is made on a way of selecting subframes in each gray scale, that is, whether light is emitted in each subframe in each gray scale or not. FIG. 1 shows a way of selecting subframes in the case where a gray scale is expressed by 5 bits and high-order bits are 3 bits while low-order bits are 2 bits. The high-order bits have 7 subframes (SF1 to SF7) since the overlapping time gray scale method is used. Accordingly, 3 bits, that is, 8 gray scales can be expressed. The length of each light emitting period (or the frequency of light emission in a certain period, namely, a weighted amount) is set to 4. It is assumed here that a gray scale level of 1 corresponds to a length of 1 of a light emitting period (or the frequency of light emission in a certain period, namely, a weighted amount). The low-order bits use the binary code time gray scale method, and have 2 subframes (SF8 and SF9). Accordingly, 2 bits, that is, 4 gray scales can be expressed. The length of each light emitting period (or the frequency of light emission in a certain period, namely, a weighted amount) is set to satisfy SF8=1 and SF9=2. Thus, 5-bit gray scales can be expressed by the 7 subframes for the high-order bits and the 2 subframes for the low-order bits, namely, 9 subframes in total.

It is to be noted that, although the length of each light emitting period (or the frequency of light emission in a certain period, that is, a weighted amount) in the subframes using the overlapping time gray scale method is set to 4, the invention is not limited to this. The length of a light emitting period (or the frequency of light emission in a certain period, that is, a weighted amount) may be different in each subframe.

It is to be noted that a light emitting period is used in the case where light is emitted continuously, and the frequency of light emission is used in the case where light is repeatedly turned on and off in a certain period. A typical display using the frequency of light emission is a plasma display. A typical display using a light emitting period is an organic EL display.

Here, how to use FIG. 1 is described. Light is emitted in a subframe denoted by a circle, and no light is emitted in a subframe denoted by a cross. Gray scales are expressed by selecting a subframe where light is emitted. For example, in a gray scale level of 0, no light is emitted in SF1 to SF 9. In a gray scale level of 1, no light is emitted in SF1 to SF 7 and SF9, and light is emitted in SF8. In a gray scale level of 4, no light is emitted in SF2 to SF9, and light is emitted in SF1. In a gray scale level of 5, no light is emitted in SF2 to SF7 and SF9 and light is emitted in SF1 and SF8. In a gray scale level of 8, no light is emitted in SF3 to SF9 and light is emitted in SF1 and SF2. Note that SF1 to SF7 are subframes for the high-order bits, and SF8 and SF9 are subframes for the low-order bits.

Subsequently, a way of expressing a gray scale level, that is, a way of selecting each subframe. In gray scale levels of 0 to 3, no light is emitted in SF1 to SF7 since the overlapping time gray scale method is used for the high-order 3 bits. In gray scale levels of 4 to 7, light is emitted in SF1, and no light is emitted in SF2 to SF7. In gray scale levels of 8 to 11, light is emitted in SF1 and SF2, and no light is emitted in SF3 to SF7. In gray scale levels of 12 to 15, light is emitted in SF1, SF2, and SF3, and no light is emitted in SF4 to SF7. When a gray scale level further increases, whether light is emitted or not is selected similarly.

Thus, the high-order 3 bits express a gray scale by sequentially adding a light emitting period in each subframe. That is, as a gray scale level increases, light is emitted in more subframes. Therefore, in a gray scale level of 4 or more, light is always emitted in SF1. In a gray scale level of 8 or more, light is always emitted in SF2. In a gray scale level of 12 or more, light is always emitted in SF3. The same applies to SF4 to SF7. That is to say, in a subframe where light is emitted when a gray scale level is low, light is emitted when a gray scale level is high.

By using such a driving method, pseudo contours can be reduced. This is because in a certain gray scale level, light is emitted in all the subframes where light is emitted when a gray scale level is lower than that. Therefore, even if eyes move, it can be prevented that an image is displayed with inaccurate luminance in a boundary of gray scale levels.

Next, a way of expressing gray scales in the low-order bits is described. When light is emitted in the same subframe in the subframes for the high-order bits, gray scales cannot be expressed in detail if nothing is done. Thus, in order to express gray scales in more detail, namely, in order to express low-order bits, the binary code time gray scale method is used. That is to say, in a gray scale level of 0, no light is emitted in SF8 and SF 9. In a gray scale level of 1, light is emitted in SF8, and no light is emitted in SF9. In a gray scale level of 2, no light is emitted in SF8, and light is emitted in SF9. In a gray scale level of 3, light is emitted in SF8 and SF9. Similarly, in a gray scale level of 4, no light is emitted in SF8 and SF9. In a gray scale level of 5, light is emitted in SF8 and no light is emitted in SF9. In a gray scale level of 6, no light is emitted in SF8 and light is emitted in SF9. In a gray scale level of 7, light is emitted in SF8 and SF9.

In this manner, the length of each subframe is set based on a binary number so as to be equal to the power of 2 like 1:2:4:8: . . . :2ⁿ, and light emission and non-light emission of each subframe are controlled to express n-bit gray scales. As a result, when light is emitted in the same subframe in the subframes for the high-order bits, grayscales can be expressed in more detail. That is to say, the low-order bits can be expressed.

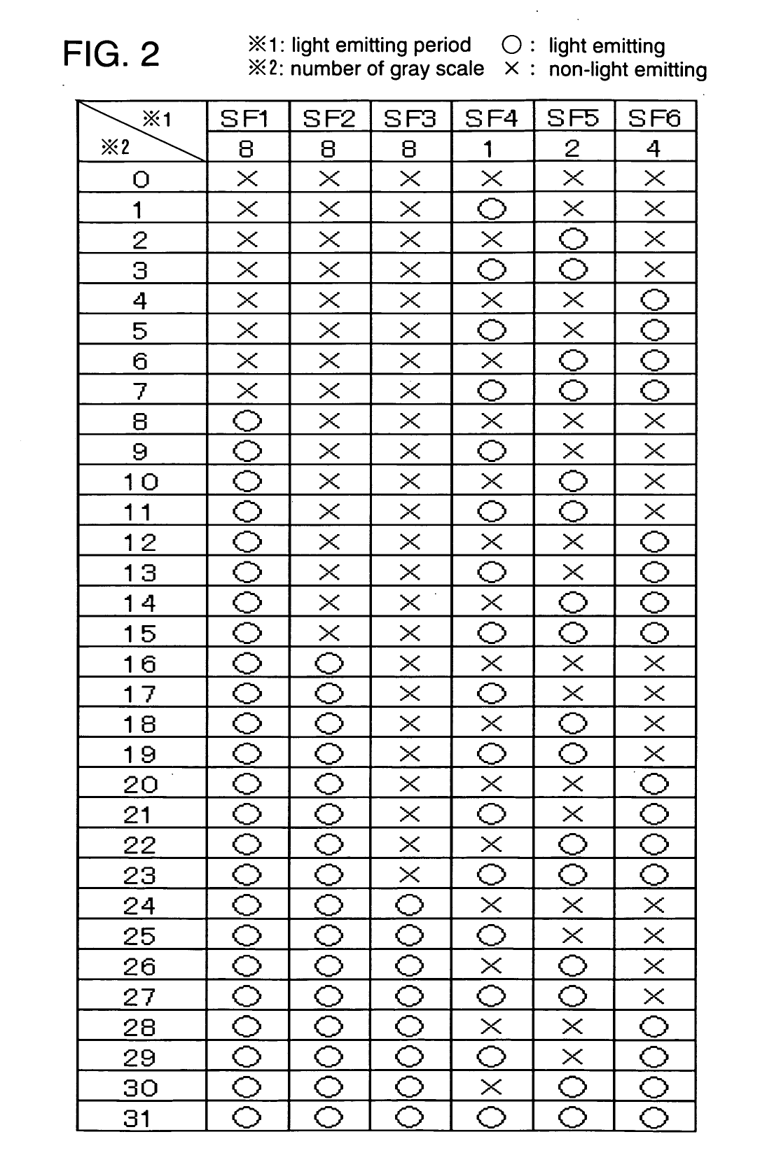

In this manner, FIG. 1 shows the way of selecting subframes in the case where the high-order bits are 3 bits and the low-order bits are 2 bits. Next, a way of selecting subframes in the case where the high-order bits are 2 bits and the low-order bits are 3 bits is shown in FIG. 2.

The high-order 2 bits are expressed using 3 subframes (SF1 to SF3) since the overlapping time gray scale method is used. According to this, 2 bits, that is, 4 gray scales can be expressed. The low-order 3 bits are expressed using 3 subframes (SF4 to SF6) since the binary code time gray scale method is used. According to this, 3 bits, that is, 8 gray scales can be expressed. Thus, 5-bit gray scales can be expressed by the 3 subframes for the high-order bits and the 3 subframes for the low-order bits, namely, 6 subframes in total.

In this manner, by increasing the number of bits using the binary code time gray scale method, the total number of subframes can be reduced. In that case, however, when the gray scale level is changed by one, subframes to be selected, namely, the way of selecting subframes where light is emitted may be significantly changed. In such a case, a pseudo contour easily occurs. Accordingly, the number of bits using the binary code time gray scale method may be determined by a trade-off between the number of subframes and the effect of reducing pseudo contours.

It is to be noted that in the case where the high-order bits are 2 bits and the low-order bits are 3 bits, the length of a light emitting period in each subframe using the overlapping time gray scale method is 8. This is because the low-order bits using the binary code time gray scale method are 3 bits. Since 3 bits, that is, 8 gray scales can be expressed, a light emitting period is required to increase by at most 8 in the overlapping time gray scale method. In view of the abovementioned, it is desirable that the length of each light emitting period in subframes using the overlapping time gray scale method be equal to or less than the length of a light emitting period in the highest gray scale level using the binary code time gray scale method. When the length of each light emitting period in subframes using the overlapping time gray scale method is shorter than the length of a light emitting period in the highest gray scale level using the binary code time gray scale method, some of the ways of selecting subframes are not used actually in the binary code time gray scale method.

It is to be noted that the length of a light emitting period is appropriately changed depending on the total number of gray scales (number of bits), the total number of subframes, and the like. Therefore, when the total number of gray scales (number of bits), or the total number of subframes is changed, the length of a period (for example, us) where light is emitted actually may be changed even if the length of the light emitting period is the same.

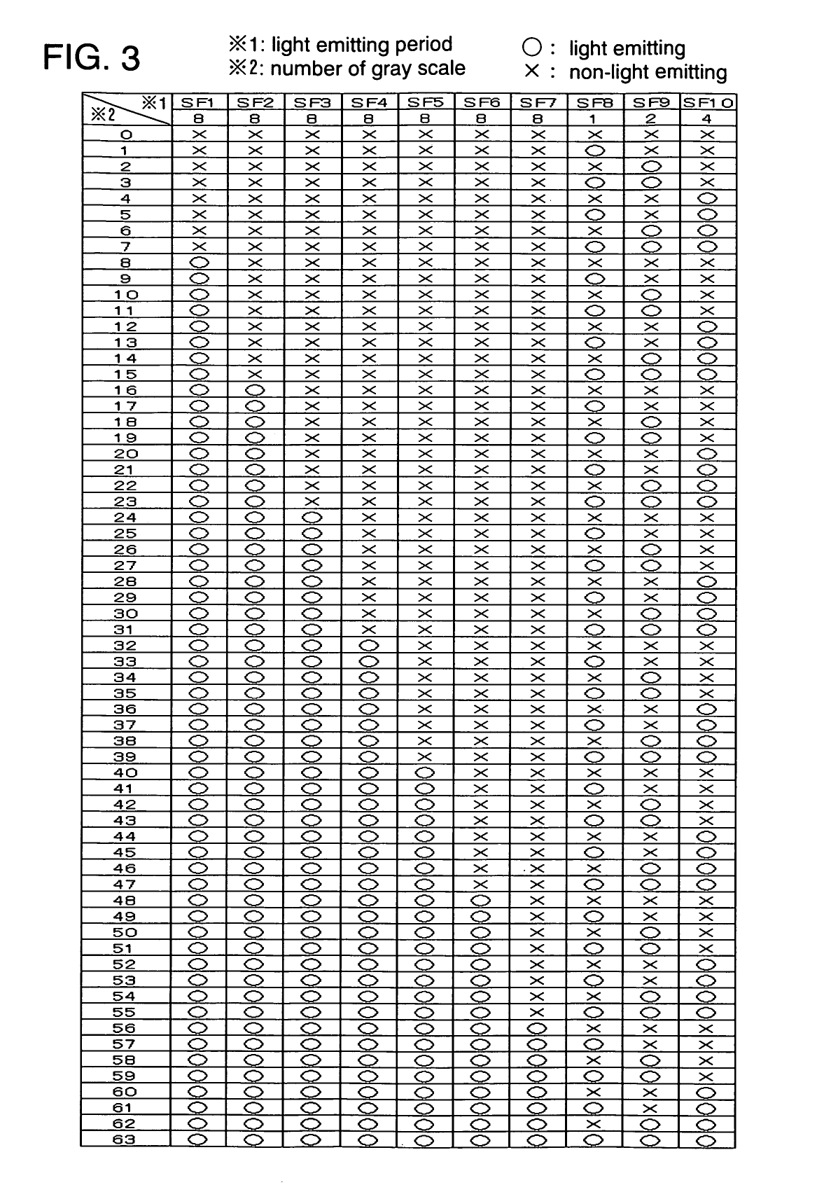

Subsequently, a case of expressing 6-bit gray scales is considered. FIG. 3 shows a way of selecting subframes in the case where the high-order bits are 3 bits, and the low-order bits are 3 bits.

The high-order 3 bits are expressed using 7 subframes (SF1 to SF7) since the overlapping time gray scale method is used. According to this, 3 bits, that is, 8 gray scales can be expressed. The low-order 3 bits are expressed using 3 subframes (SF 8 to SF 10) since the binary code time gray scale method is used. According to this, 3 bits, that is, 8 gray scales can be expressed. The length of each light emitting period in the subframes using the overlapping time gray scale method is 8. Thus, 6-bit gray scales can be expressed by the 7 subframes for the high-order bits and the 3 subframes for the low-order bits, namely, 10 subframes in total.

It is to be noted that in the case of expressing 6-bit gray scales, similarly to FIG. 2, gray scales can be expressed by arbitrarily dividing into the high-order bits and the low-order bits and using the overlapping time gray scale method and the binary code time gray scale method in combination.

Although description is thus made on the cases where 5-bit or 6-bit gray scales are expressed in FIGS. 1 to 3, various numbers of bits may be adopted similarly. That is to say, in the case where n-bit gray scales are expressed, and the high-order bits are a bits while the low-order bits are b bits, the number of subframes in the high-order bits using the overlapping time gray scale method is at least (2^{a}−1), and the number of subframes in the low-order bits using the binary code time gray scale method is at least b. The length of a light emitting period in a subframe using the overlapping time gray scale method is 2^{b}.

Thus, by combining the overlapping time gray scale method and the binary code time gray scale method, images with reduced pseudo contours and a larger number of gray scales can be displayed without increasing the number of subframes.

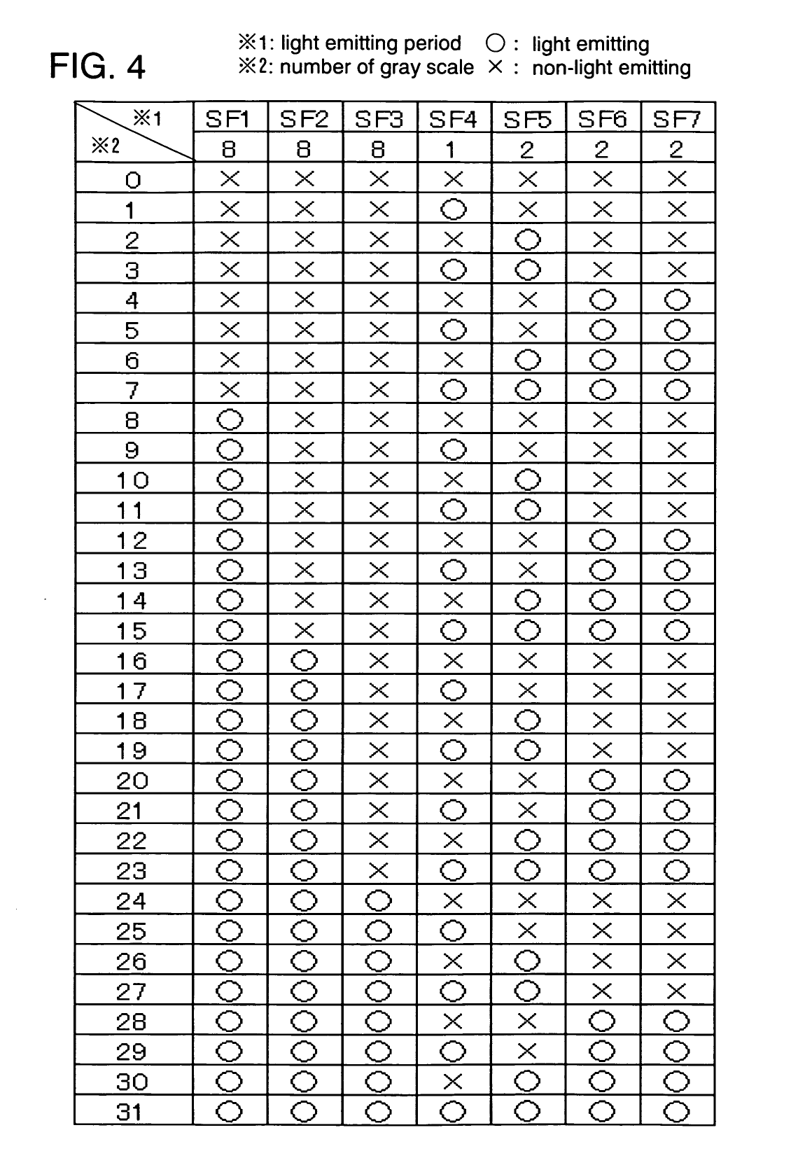

It is to be noted that in the case of using the binary code time gray scale method of expressing the low-order bits, the length of a light emitting period of each subframe, which is described above as an example, is equal to the power of 2 like 1:2:4:8: . . . :2ⁿ; however, the invention is not limited to this. For example, a subframe for the high-order bits in the case of using the binary code time gray scale method, namely, a subframe with a long period may be divided. For example, a subframe with a length of 4 may be divided into two subframes each with a length of 2 like 1:2:(2+2):(3+3+2): . . . . Alternatively, a subframe with a length of 8 may be divided into three subframes with a length of 3, a length of 3, and a length of 2. FIG. 4 shows the case where SF6 in FIG. 2 is divided into two subframes SF6 and SF7, each of which has a light emitting period of 2.

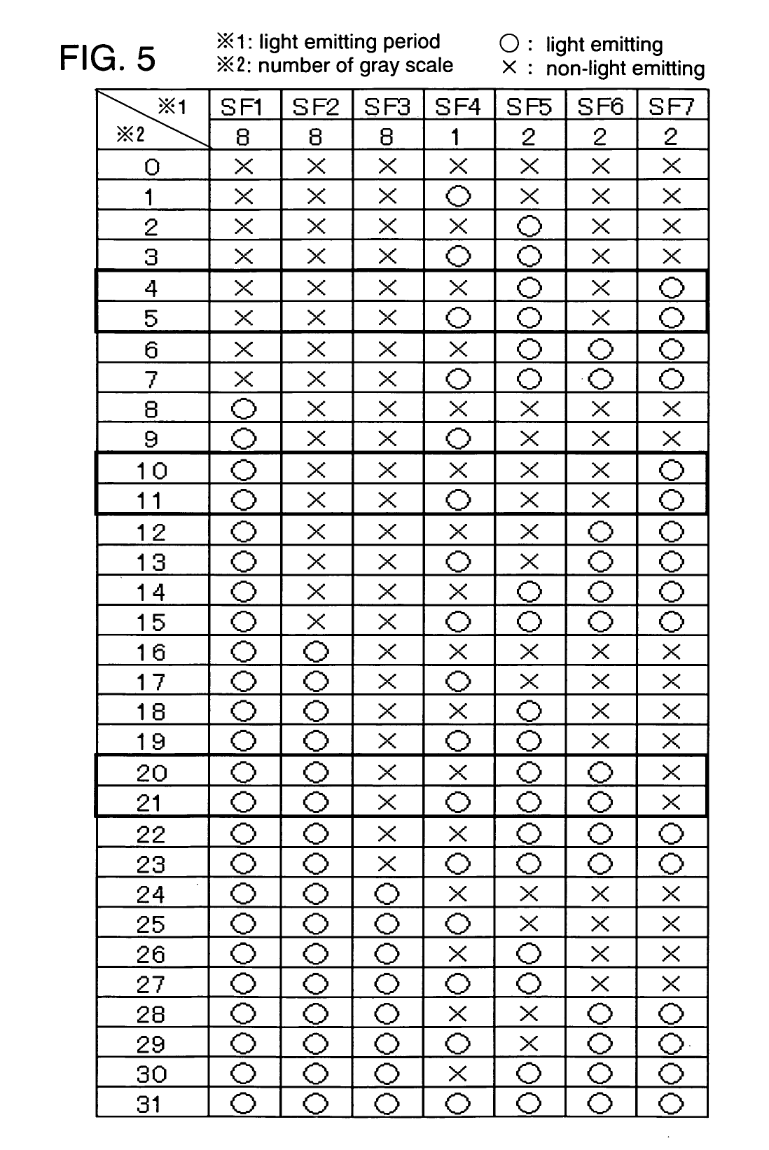

When attention focused on FIG. 4 here, it is found that some of the subframes for the low-order bits using the binary code time gray scale method have the same light emitting period. In such a case, it is possible to change subframes where light is emitted. For example, as shown in FIG. 5, in gray scale levels 4, 5, 10, 11, 20, 21, and the like, the way of selecting light emitting periods may be differ from the case shown in FIG. 4. In the case of a gray scale level of 4, light is emitted in SF6 and SF7 in FIG. 4, while light is emitted in SF5 and SF7 in FIG. 5. In fact, light emitting period may be selected from light emitting periods with the same period, and thus there are more ways of selecting. Accordingly, in a certain gray scale level, selection of light emitting periods may be changed depending on time or place. That is to say, selection of light emitting periods may be changed depending on time, or selection of light emitting periods may be changed depending on a pixel. Further, it may be changed depending on time and a pixel.

For example, when a certain gray scale level is expressed, a way of selecting subframes may be changed between an odd-numbered frame and an even-numbered frame. Further, when a certain gray scale level is expressed, a way of selecting subframes may be changed between when displaying a pixel of an odd-numbered row and when displaying a pixel of an even-numbered row. Furthermore, when a certain gray scale level is expressed, a way of selecting subframes may be changed between when displaying a pixel of an odd-numbered column and when displaying a pixel of an even-numbered column.

Further, description is made on another example where in the case of using the binary code time gray scale method of expressing the low-order bits, the length of a light emitting period of each subframe is not equal to the power of 2. Basically, gray scales may be continuously expressed by emitting light in each subframe. To achieve this, the length of a light emitting period of a subframe is required to be approximately equal to the total light emitting periods of subframes each having a shorter light emitting period than that, so that gray scales can be continuously expressed.

For example, if it is assumed that the ratio of the length of a light emitting period of each subframe is 1:1:2:3, all gray scale levels of 0 to 7 can be continuously expressed. That is to say, if the length of a light emitting period of a subframe i is Ti, a length obtained by subtracting a light emitting period of 1 from Ti may be equal to or shorter than the total light emitting periods of a subframe 1 to a subframe (i-1). According to this, all the grays scale levels can be continuously expressed by appropriately selecting each subframe. For example, in the case of T1:T2:T3:T4, a length obtained by subtracting a light emitting period of 1 from T4 may be equal to or shorter than the total light emitting periods of T1 to T3. A length obtained by subtracting a light emitting period of 1 from T3 may be equal to or shorter than the total light emitting periods of T1 and T2, and a length obtained by subtracting a light emitting period of 1 from T2 may be equal to or shorter than T1. According to this, all the gray scale levels can be continuously expressed.

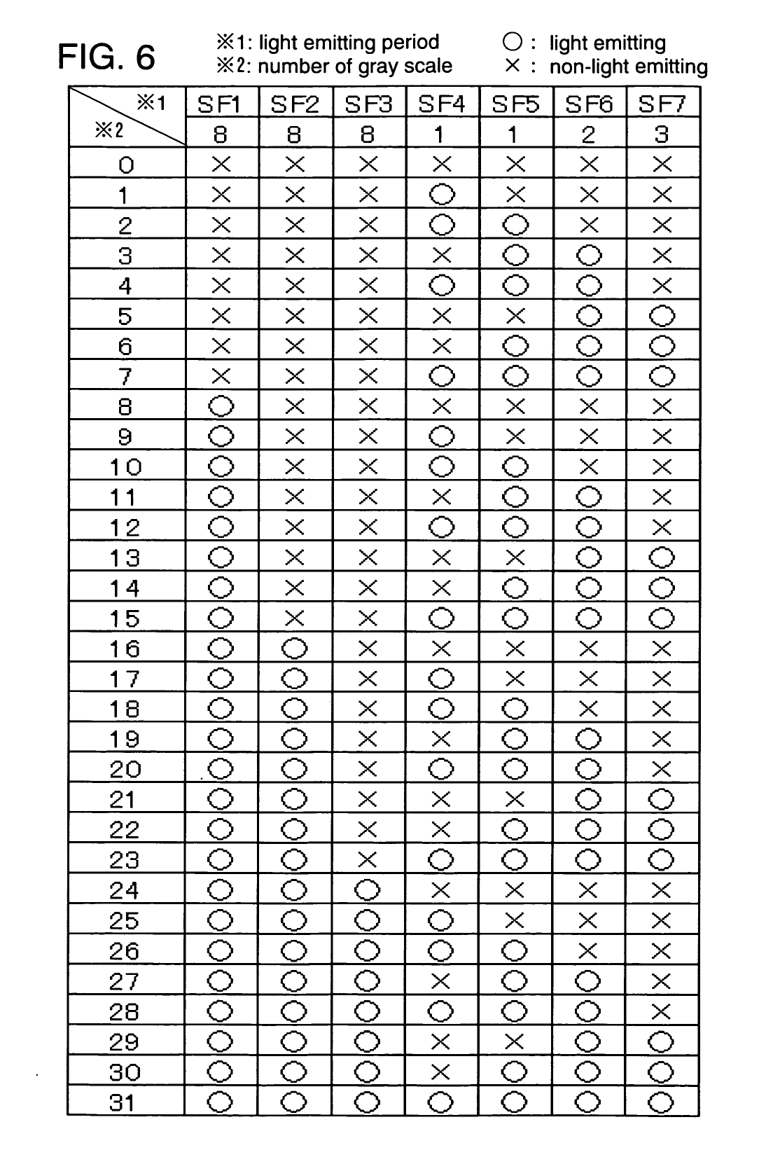

A way of thus selecting subframes in the case where the high-order bits are 2 bits and the low-order bits are 3 bits is shown in FIG. 6. The length of a light emitting period in each subframe for the low-order bits is set to 1:1:2:3. According to this, 8 gray scales from 0 to 7 can be expressed. In this manner, when light is emitted in subframes as shown in FIG. 6, a way of selecting subframes can be prevented from being significantly changed when a gray scale level is changed. Therefore, pseudo contours can be reduced.

When attention focused on FIG. 6 here, it is found that when expressing a certain gray scale level, there are a plurality of ways of selecting subframes for the lower bits using the binary code time gray scale method. For example, in the case of expressing a gray scale level of 2, it is possible to select two subframes each having a light emitting period of 1 or one subframe having a light emitting period of 2. Similarly, in the case of expressing a gray scale level of 3, it is possible to select one subframe having a light emitting period of 3 or two subframes having light emitting periods of 1 and 2. It is to be noted that there are a plurality of subframes each having a light emitting period of 1. Accordingly, either of them may be selected.

In this manner, in the case of expressing one gray scale level, there are a plurality of ways of selecting subframes. Accordingly, in a certain gray scale level, a way of selecting subframes may be changed depending on time or place. That is to say, a way of selecting subframes may be changed depending on time, or a way of selecting subframes may be changed depending on a pixel. Further, it may be changed depending on time and a pixel.

For example, when a certain gray scale level is expressed, a way of selecting subframes may be changed between an odd-numbered frame and an even-numbered frame. Further, when a certain gray scale level is expressed, a way of selecting subframes may be changed between when displaying a pixel of an odd-numbered row and when displaying a pixel of an even-numbered row. Furthermore, when a certain gray scale level is expressed, a way of selecting subframes may be changed between when displaying a pixel of an odd-numbered column and when displaying a pixel of an even-numbered column.

It is to be noted that although the above description is made on the case where gray scales are expressed by combining the overlapping time gray scale method and the binary code time gray scale method, another gray scale method may be additionally combined. For example, an area gray scale method may be additionally combined, where gray scales are expressed by dividing one pixel into a plurality of subpixels and changing an area where light is emitted. As a result, pseudo contours can be further reduced.

The above description is made on the case where a light emitting period increases in linear proportion to a gray scale level. Subsequently, description is made on a case where a gamma correction is performed. The gamma correction is performed so that a light emitting period increases nonlinearly as a gray scale level increases. Even when luminance increases in linear proportion, human eyes cannot sense that luminance increases in proportion. As luminance increases, the difference of brightness is less visible to human eyes. Therefore, in order that the difference of brightness is visible to human eyes, it is required that a light emitting period increases as a gray scale level increases, that is, a gamma correction is performed.

As the simplest method, a larger number of bits (gray scale levels) than the number of bits (gray scale levels) to be actually expressed are prepared. For example, when 6 bits (64 gray scales) are expressed, 8 bits (256 gray scales) are actually prepared to be expressed. When actually performing the display, 6 bits (64 gray scales) are expressed so that the luminance of a gray scale level has a non-linear shape. Accordingly, a gamma correction can be achieved.

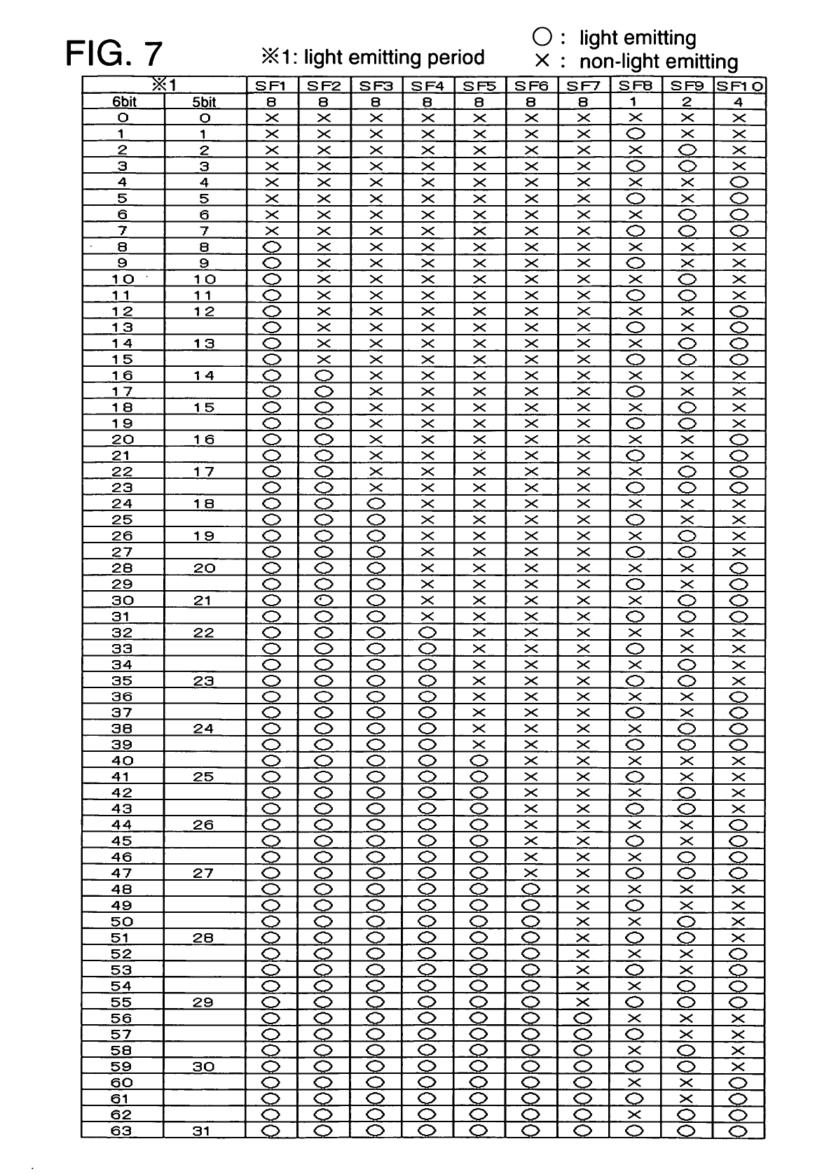

As an example, FIG. 7 shows a way of selecting subframes in the case where 6 bits are prepared to be expressed although 5 bits are actually expressed by performing a gamma correction. In FIG. 7, gray scale levels of 0 to 12 in 5 bits are the same as those in 6 bits. However, as for a gray scale level of 13 in 5 bits, to which a gamma correction has been performed, light is emitted using a way of selecting subframes in the case of a gray scale level of 14 in 6 bits. Similarly, as for a gray scale level of 14 in 5 bits, to which a gamma correction has been performed, a gray scale level of 16 in 6 bits is actually expressed. As for a gray scale level of 15 in 5 bits, to which a gamma correction has been performed, a gray scale level of 18 in 6 bits is actually expressed. Thus, display may be performed in accordance with a table in which gray scale levels in 5 bits, to which a gamma correction has been performed, are related to gray scale levels in 6 bits. In this manner, a gamma correction can be achieved.

It is to be noted that the table in which gray scale levels in 5 bits, to which a gamma correction is performed, are related to gray scale levels in 6 bits can be changed appropriately. Accordingly, by changing the table, the level of a gamma correction can be easily changed.

Further, the number of bits (for example, p bits, p is an integer here) prepared to be expressed and the number of bits (for example, q bits, q is an integer here) to be expressed after a gamma correction are not limited to these. In the case where display is performed after a gamma correction, the number of bits p is desirably set as large as possible to express gray scales smoothly. It is to be noted that too large number of bits p may adversely affect such that the number of subframes is too large. Therefore, a relation between the number of bits q and the number of bits p is desirably set to q+2≦p≦q+5. As a result, gray scales can be expressed smoothly without increasing the number of subframes too much.

As another method of performing a gamma correction, the length of a light emitting period in each subframe is made different in the case where the overlapping time gray scale method is used for high-order bits.

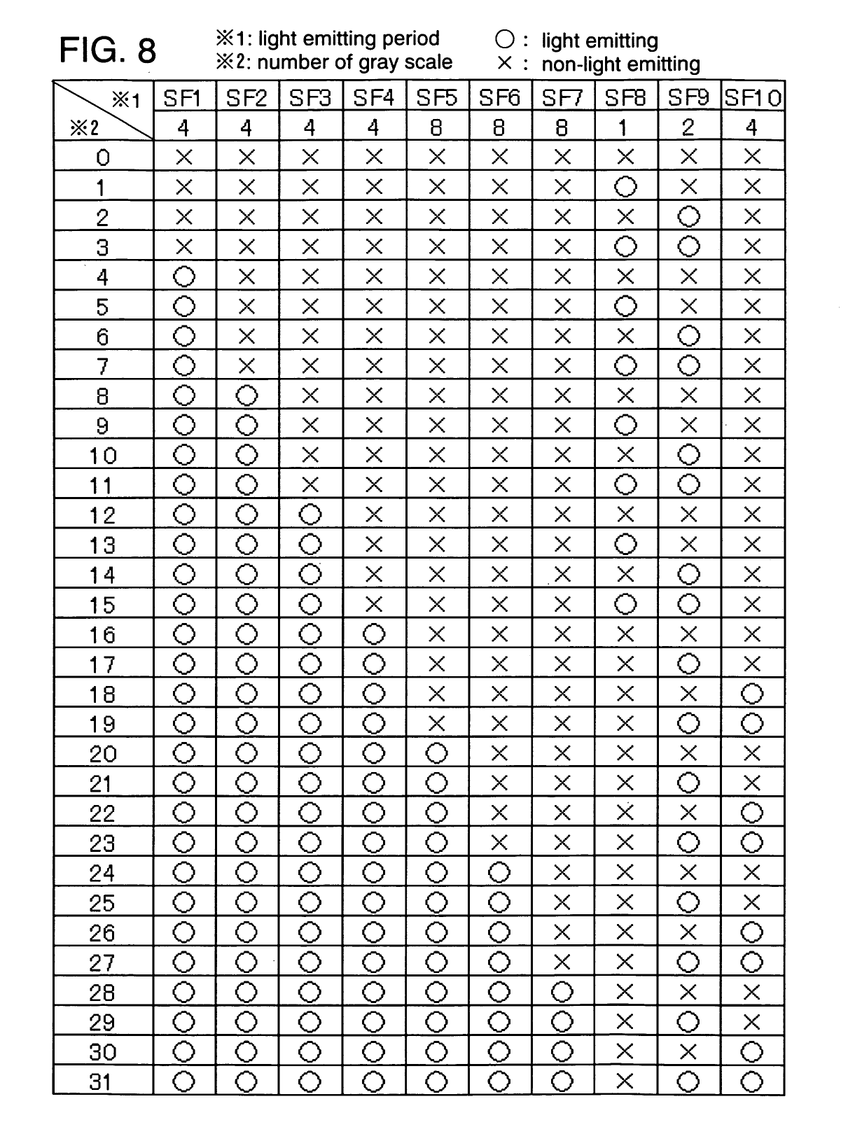

As an example, FIG. 8 shows a way of selecting subframes in the case where gray scale levels of 0 to 15 are normally expressed and the amount of change in the length of a light emitting period in relation to gray scale levels is twice in gray scale levels of 16 to 31. This case is different from FIG. 1 in that each light emitting period of subframe 5 (SF 5) to subframe 7 (SF7), which correspond to subframes for higher-order bits among subframes using the overlapping time gray scale method that is for the high-order bits, is twice as long as that of FIG. 1, and subframes are added for the low-order bits using the binary code time gray scale method.

In gray scale levels of 0 to 15, subframes using the binary code time gray scale method are SF8 and SF9. On the other hand, in gray scale levels of 16 to 31, subframes using the binary code time gray scale method are SF9 and SF10. In this manner, a light emitting period is changed smoothly as a gray scale level increases.

In this manner, pseudo contours can be reduced.

It is to be noted that in FIG. 8, the length of a light emitting period in a subframe using the overlapping time gray scale method is changed twice, though the invention is not limited to this. It may be controlled in accordance with a gamma value when a gamma correction is performed. That is to say, the length of a light emitting period in a subframe using the overlapping time gray scale method may be changed and increased.

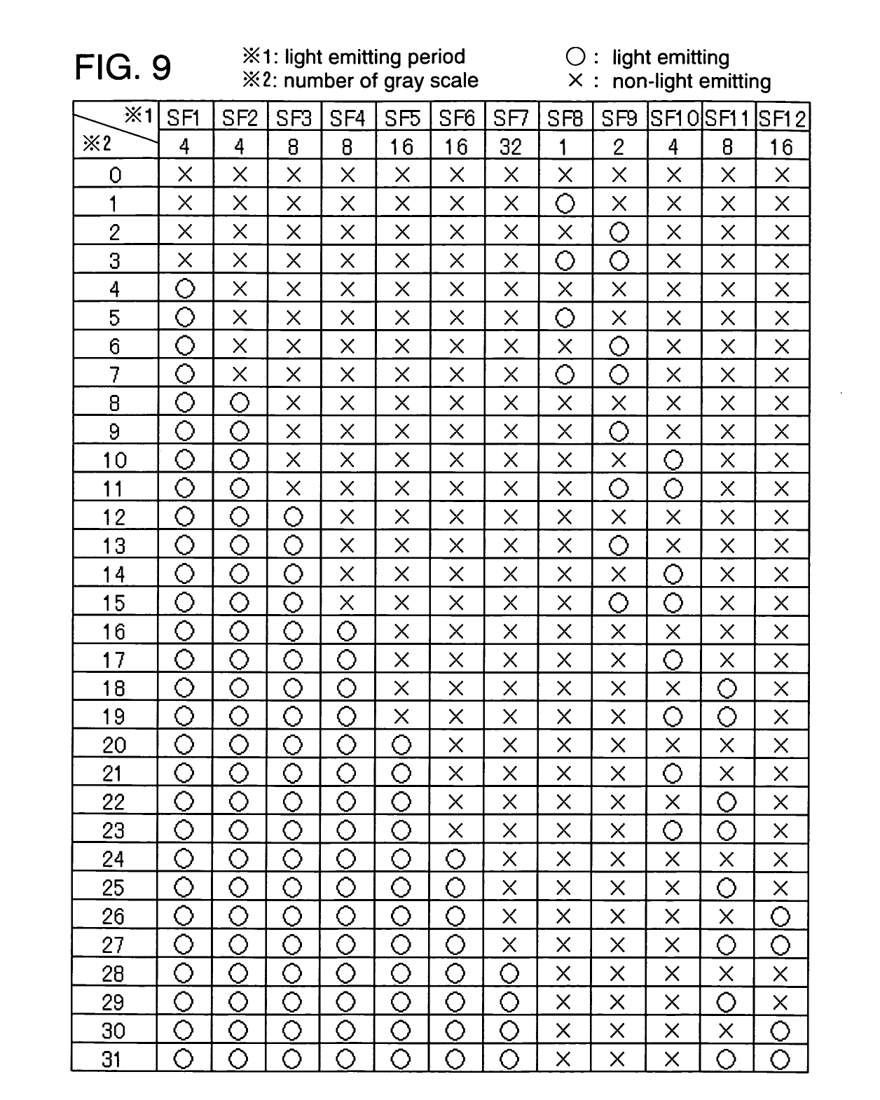

It is to be noted that although a gray scale region is divided into two in FIG. 8, the invention is not limited to this, and it may be divided into more regions. As an example, the case of dividing into four regions is shown in FIG. 9.

First, a region is divided into gray scale levels of 0 to 7, 8 to 15, 16 to 23, and 24 to 31. The gray scale levels of 0 to 7 are expressed normally, the amount of change in the light emitting period in relation to a gray scale level is twice in the gray scale levels of 8 to 15, the amount of change in the light emitting period in relation to a gray scale level is further twice in the gray scale levels of 16 to 23, and the amount of change in the light emitting period in relation to a gray scale level is further twice in the gray scale levels of 24 to 31. In this case, the length of a light emitting period is doubled sequentially in a subframe for higher-order bit among subframes using the overlapping time gray scale method that is for the high-order bits. In addition, the number of subframes further increases for low-order bits using the binary code time gray scale method.

In the gray scale levels of 0 to 7, subframes using the binary code time gray scale method are SF8 and SF9. In the gray scale levels of 8 to 15, subframes using the binary code time gray scale method are SF9 and SF10. In the gray scale levels of 16 to 23, subframes using the binary code time gray scale method are SF10 and SF11. In the gray scale levels of 24 to 31, subframes using the binary code time gray scale method are SF11 and SF12. In this manner, a light emitting period is changed smoothly as a gray scale level increases.

It is to be noted that although the length of a light emitting period in relation to a gray scale level is doubled for each region of gray scales, the invention is not limited to this. The length may increase by the power of 2, for example, by 4 times or 8 times. Alternatively, it may increase little by little. The length may be controlled in accordance with a gamma value when a gamma correction is performed. That is to say, the length of a light emitting period in each subframe using the overlapping time gray scale method may be changed and increased.

The above description is made on the way of expressing gray scales, that is, the way of selecting subframes. Subsequently, description is made on the order that a subframe appears.

Although the case of FIG. 1 is used here as an example, the invention is not limited to this and can be applied to other figures as well.

First, as the most basic structure, one frame is constituted by SF8, SF9, SF1, SF2, SF3, SF4, SF5, SF6, and SF7 in this order. A subframe having the shortest light emitting period is provided first, followed by subframes arranged according to the overlapping time gray scale method.

Alternatively, one frame may be constituted by SF7, SF6, SF5, SF4, SF3, SF2, SF1, SF9, and SF8 as a reversed order. The binary code time gray scale method and the overlapping time gray scale method may appear in the opposite order. For example, one frame may be constituted by SF1, SF2, SF3, SF4, SF5, SF6, SF7, SF8, and SF9 in this order.

Subsequently, a subframe using the binary code time gray scale method is sandwiched between any of subframes using the overlapping time gray scale method. For example, the order is such that SF1, SF8, SF2, SF9, SF3, SF4, SF5, SF6, and SF7. That is, SF8 and SF9 that are subframes using the binary code time gray scale method are sandwiched between SF1 and SF2, and between SF2 and SF3, which are subframes using the overlapping time gray scale method. It is to be noted that a position where the subframes using the binary code time gray scale method are sandwiched is not limited to this. Further, the number of subframes that are sandwiched is not also limited to this.

In this manner, by sandwiching a subframe using the binary code time gray scale method between subframes using the overlapping time gray scale method, pseudo contours are less visible because of trick of eyesight.

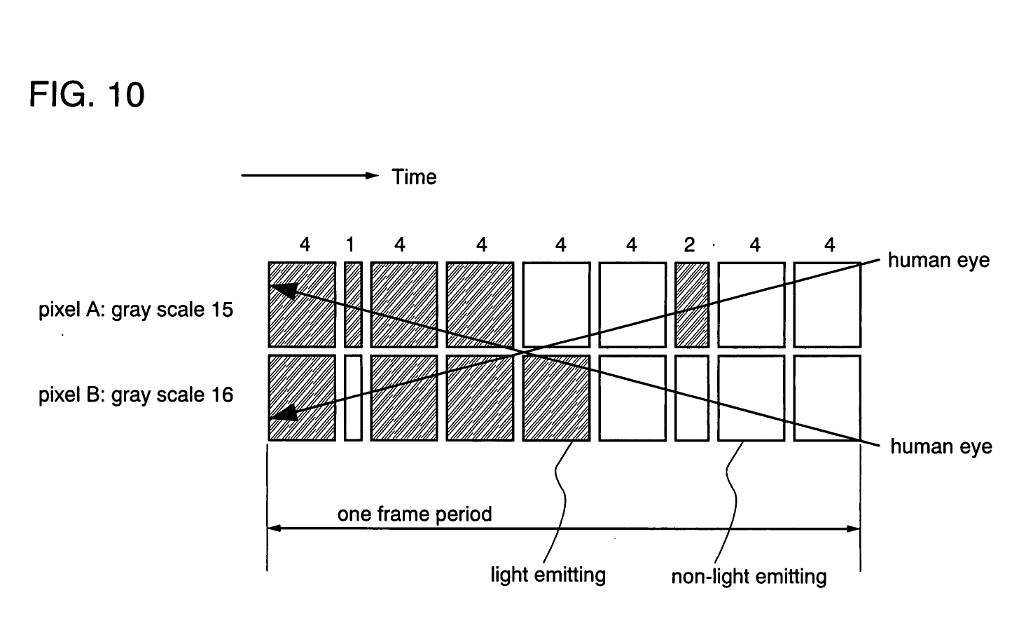

FIG. 10 shows the case where 5-bit gray scales are expressed using SF1, SF8, SF2, SF3, SF4, SF5, SF9, SF6, and SF7 arranged in this order. It is assumed that a gray scale level of 15 is expressed in a pixel A while a gray scale level of 16 is expressed in a pixel B. Here, when eyes move, depending on a line of sight, a gray scale level of 17 (=4+1+4+4+4) is sometimes visible and a gray scale level of 14 (=4+4+4+2) is sometimes visible. Although gray scale levels of 15 and 16 should be visible, gray scale levels of 16 and 17 are actually visible. Therefore, a gap between gray scales is so small that pseudo contours are reduced.

It is to be noted that subframes using the overlapping time gray scale method may be arranged in the order in which light is emitted (for example, SF1, SF2, SF3, SF4, SF5, SF6, and SF7), or in the reversed order (for example, SF7, SF6, SF5, SF4, SF3, SF2, and SF1).

Alternatively, light emission may be started from a middle subframe (SF7, SF5, SF5, SF3, SF2, SF4, and SF6). Accordingly, pseudo contours occurring in a boundary between the first frame and the second frame are reduced. A so-called moving image pseudo contours can be reduced.

Alternatively, subframes may be arranged at random (for example, SF1, SF6, SF2, SF4, SF3, SF5, and SF7). According to this, pseudo contours are less visible because of trick of eyesight.

As an example, it is assumed that subframes in one entire frame appear in the order of SF1, SF8, SF5, SF7, SF2, SF4, SF9, SF3, and SF6. This corresponds to the case where subframes using the overlapping time gray scale method are arranged at random, and subframes using the binary code time gray scale method are arranged between the subframes using the overlapping time gray scale method.

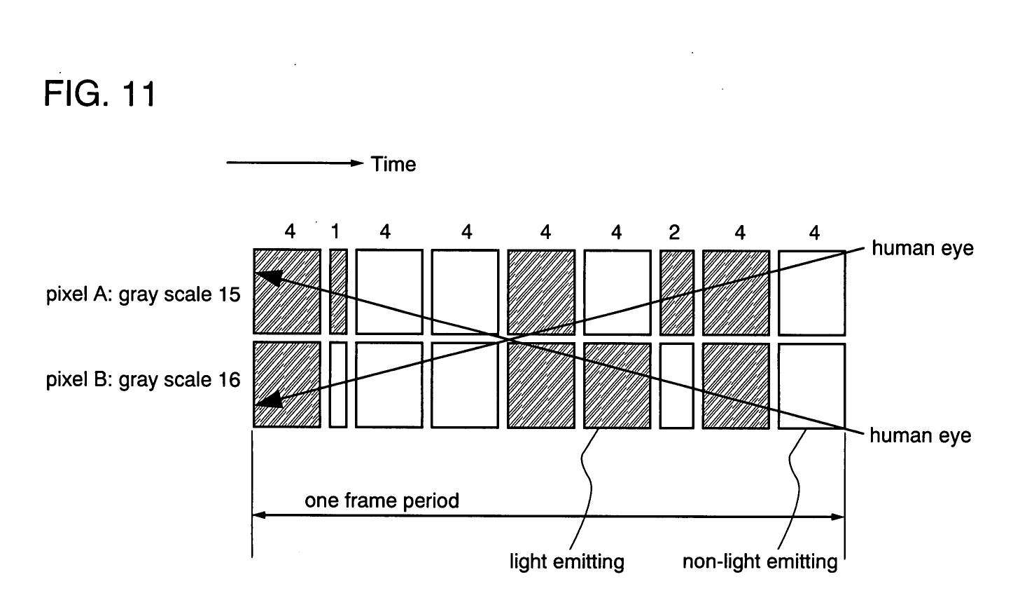

Such a case is shown in FIG. 11. Here, when eyes move, depending on a line of sight, a gray scale level of 17 (=4+1+4+4+4) is sometimes visible and a gray scale level of 14 (=4+4+2+4) is sometimes visible. Although gray scale levels of 15 and 16 should be visible, gray scale levels of 16 and 17 are actually visible. Therefore, the case of FIG. 10 is not largely different from the case of FIG. 11.

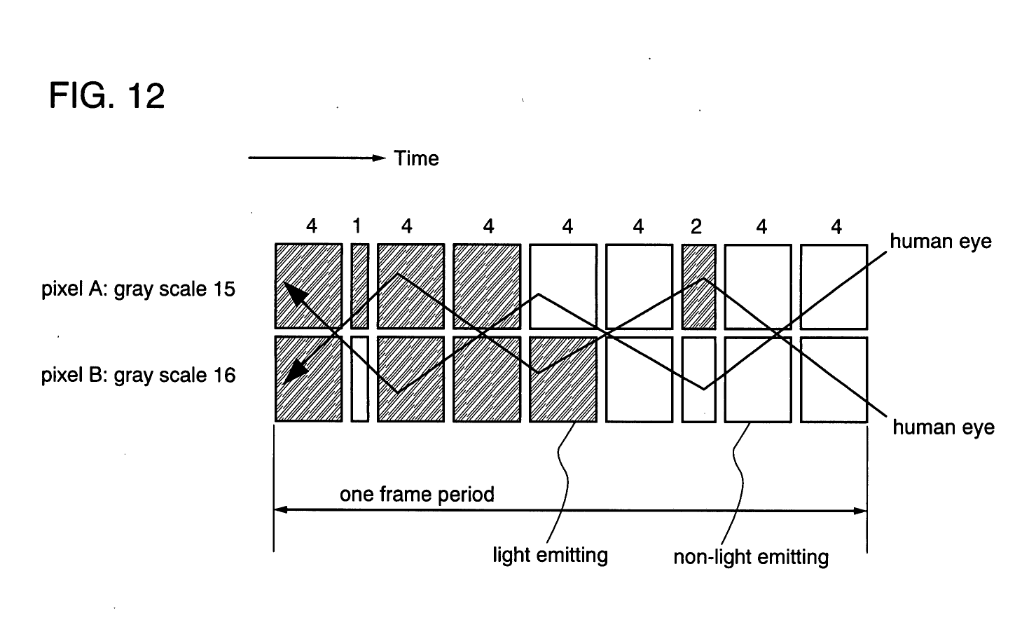

However, it is assumed that eyes move rapidly. For example, FIG. 12 shows the case where eyes move rapidly in FIG. 10. When eyes move rapidly, depending on a line of sight, a gray scale level of 12 (=4+4+4) is sometimes visible and a gray scale level of 19 (=4+1+4+4+4+2) is sometimes visible. Although gray scale levels of 15 and 16 should be visible, gray scale levels of 12 to 19 are actually visible.

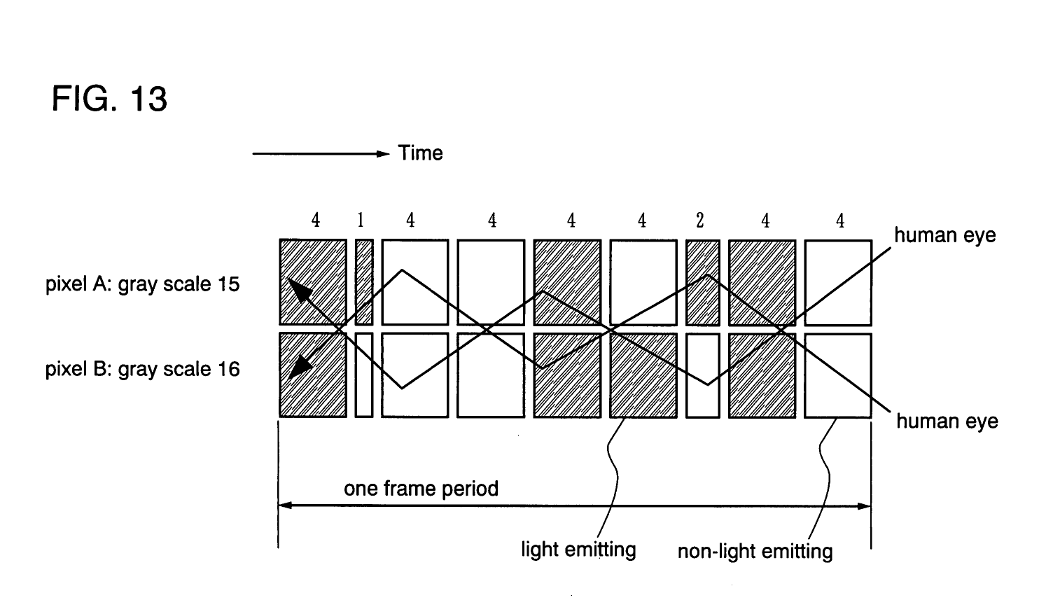

On the other hand, FIG. 13 shows the case where eyes move rapidly in FIG. 11. When eyes move rapidly, depending on a line of sight, a gray scale level of 16 (=4+4+4+4) is sometimes visible and a gray scale level of 15 (=4+1+4+2+4) is sometimes visible. Gray scale levels of 15 and 16 that are to be visible are expressed almost correctly. Therefore, the case of FIG. 12 is largely different from the case of FIG. 13. That is to say, subframes according to the overlapping time gray scale method are desirably arranged as randomly as possible so as to increase the effect of reducing pseudo contours.

In this manner, the order in which all subframes appear may be determined by determining the order of subframes using the overlapping time gray scale method and sandwiching subframes using the binary code time gray scale method between these subframes.

At this time, subframes using the binary code time gray scale method may be arranged in order from a subframe with the shortest light emitting period (for example, SF8 and SF9), or in the reversed order (for example, SF9 and SF8). Alternatively, light emission may be started from a middle subframe. Alternatively, the subframes may be arranged at random. According to this, pseudo contours are less visible because of trick of eyesight.

Further, in the case where subframes using the binary code time gray scale method are sandwiched between subframes using the overlapping time gray scale method, the number of the sandwiched subframes is not limited.

Further, the order in which all subframes appear may be determined by thus determining the order of subframes using the binary code time gray scale method and sandwiching subframes using the overlapping time gray scale method between these subframes.

In this manner, subframes using the binary code time gray scale method are arranged between subframes using the overlapping time gray scale method so that the subframes are evenly arranged. As a result, pseudo contours can be reduced because of trick of eyesight.

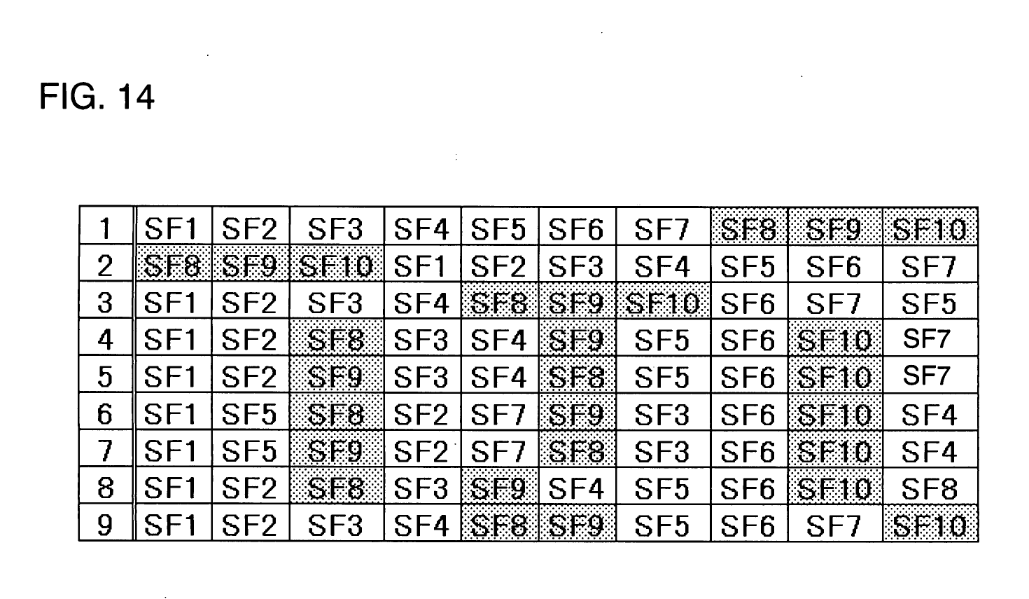

FIG. 14 shows examples of a pattern of the order in which subframes appear in FIG. 3.

As a first pattern, subframes appear in the order of SF1, SF2, SF3, SF4, SF5, SF6, SF7, SF8, SF9 and SF10. Subframes using the binary code time gray scale method are arranged together at the end of one frame.

As a second pattern, subframes appear in the order of SF8, SF9, SF10, SF1, SF2, SF3, SF4, SF5, SF6, and SF7. Subframes using the binary code time gray scale method are arranged together at the top of one frame.

As a third pattern, subframes appear in the order of SF1, SF2, SF3, SF4, SF8, SF9, SF10, SF6, SF7, and SF5. Subframes using the binary code time gray scale method are arranged together in the middle of one frame.

As a fourth pattern, subframes appear in the order of SF1, SF2, SF8, SF3, SF4, SF9, SF5, SF6, SF10, and SF8. Subframes using the overlapping time gray scale method are arranged in order. Subframes using the binary code time gray scale method are also arranged in order. After two subframes using the overlapping time gray scale method are arranged, one subframe using the binary code time gray scale method is arranged.

As a fifth pattern, subframes appear in the order of SF1, SF2, SF9, SF3, SF4, SF8, SF5, SF6, SF10, and SF8. This pattern corresponds to the fourth pattern, where the subframes using the binary code time gray scale method are arranged at random.

As a sixth pattern, subframes appear in the order of SF1, SF5, SF8, SF2, SF7, SF9, SF3, SF6, SF10, and SF4. This pattern corresponds to the fourth pattern, where the subframes using the overlapping time gray scale method are arranged at random.

As a seventh pattern, subframes appear in the order of SF1, SF5, SF9, SF2, SF7, SF8, SF3, SF6, SF10, and SF4. This pattern corresponds to the fourth pattern, where the subframes using the overlapping time gray scale method and the subframes using the binary code time gray scale method are arranged at random.

As an eighth pattern, subframes appear in the order of SF1, SF2, SF8, SF3, SF9, SF4, SF5, SF6, SF10, and SF8. In this pattern, after two subframes using the overlapping time gray scale method are arranged, one subframe using the binary code time gray scale method is arranged, one subframe using the overlapping time gray scale method is arranged, one subframe using the binary code time gray scale method is arranged, three subframes using the overlapping time gray scale method are arranged, and one subframe using the binary code time gray scale method is arranged.

As a ninth pattern, subframes appear in the order of SF1, SF2, SF3, SF4, SF8, SF9, SF5, SF6, SF7, and SF10. In this pattern, after four subframes using the overlapping time gray scale method are arranged, two subframes using the binary code time gray scale method are arranged, three subframes using the overlapping time gray scale method are arranged, and one subframe using the binary code time gray scale method is arranged.

In this manner, it is desirable that light be emitted in one subframe of a plurality of subframes corresponding to the high-order bits, light be emitted in one subframe of one or more subframes corresponding to the low-order bits, and then light be emitted in another subframe of the plurality of subframes corresponding to the high-order bits.

Further, it is desirable that light be emitted in one subframe of a plurality of subframes corresponding to the low-order bits, light be emitted in one subframe of a plurality of subframes corresponding to the high-order bits, and then light be emitted in another subframe of the plurality of subframes corresponding to the low-order bits.

Further, it is desirable that light be emitted in one subframe of a plurality of subframes corresponding to the low-order bits, light be emitted in a plurality of subframes of a plurality of subframes corresponding to the high-order bits, and then light be emitted in another subframe of the plurality of subframes corresponding to the low-order bits.

Further, it is desirable that light be emitted in one subframe of a plurality of subframes corresponding to the high-order bits, light be emitted in a plurality of subframes of a plurality of subframes corresponding to the low-order bits, and then light be emitted in another subframe of the plurality of subframes corresponding to the high-order bits.

Next, description is made on the order in which subframes appear in FIG. 4. In the case of FIG. 4, the subframe for the high-order bits using the binary code time gray scale method is divided. Therefore, the order in which subframes appear is required to be set appropriately for this case. As an example, subframes appear in the order of SF4, SF1, SF6, SF2, SF5, SF3, and SF7. In this manner, the subframes using the binary code time gray scale method are arranged between the subframes using the overlapping time gray scale method, and subframes for the high-order bits among the subframes using the binary code time gray scale method are arranged as separately as possible. As a result, pseudo contours can be reduced.

It is to be noted that the subframes using the overlapping time gray scale method may also be arranged, similarly to the case of FIG. 1, in the order in which light is emitted or the reversed order, or at random. The order in which the subframes using the binary code time gray scale method are sandwiched between the subframes using the overlapping time gray scale method may be determined appropriately so that the subframes are arranged evenly. As a result, pseudo contours can be reduced.

It is to be noted that the order in which subframes appear may be changed depending on time. For example, the order in which subframes appear may be changed between the first frame and the second frame. Further, the order in which subframes appear may be changed depending on place. For example, the order in which subframes appear may be changed between the pixel A and the pixel B. Further, the order in which subframes appear may be changed depending on time and place by combining these.

It is to be noted that although a frame frequency of 60 Hz is generally used, the invention is not limited to this. Pseudo contours may be reduced by further increasing the frame frequency. For example, a display device may be operated at about 120 Hz that is twice as high as the normal the frequency.

### Embodiment Mode 2

In this embodiment mode, an example of a timing chart is described. Although FIG. 1 is used as an example of a way of selecting subframes, the invention is not limited to this and can easily be applied to other ways of selecting subframes, other numbers of gray scale levels, and the like.

Further, although the order in which subframes appear is SF1, SF8, SF2, SF9, SF3, SF4, SF5, SF6, and SF7 as an example, the invention is not limited to this and can easily be applied to other orders.

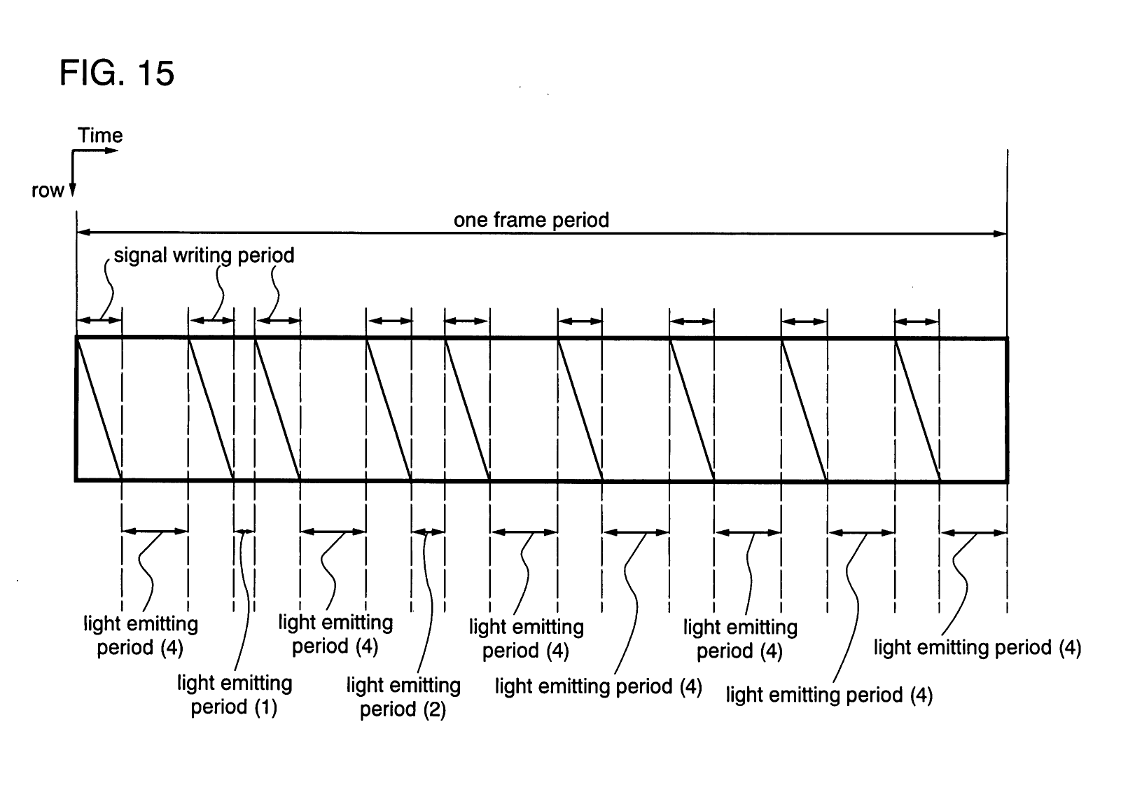

FIG. 15 shows a timing chart in the case where a period where signals are written to a pixel and a period where light is emitted are separated. First, signals for one screen are inputted to all pixels in a signal writing period. During this period, pixels emit no light. After the signal writing period, a light emitting period starts and pixels emit light. The length of the light emitting period at this time is 4. Next, a subsequent subframe starts and signals for one screen are inputted to all pixels in a signal writing period. During this period, pixels emit no light. After the signal writing period, a light emitting period starts and pixels emit light. The length of the light emitting period at this time is 1.

By repeating similar operations, the lengths of the light emitting periods are arranged in the order of 4, 1, 4, 2, 4, 4, 4, 4, and 4.

Such a driving method where a period where a signal is written to a pixel and a period where light is emitted are separated is preferably applied to a plasma display. It is to be noted that in the case where the driving method is used for a plasma display, an initialization operation and the like are required, which are omitted here for simplicity.

Further, this driving method is also preferably applied to an organic EL display, a field emission display, a display using a Digital Micromirror Device (DMD), and the like.

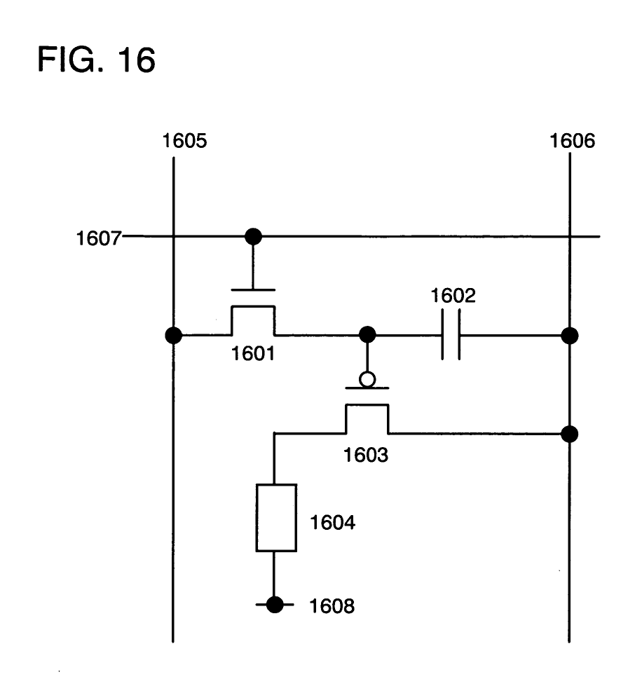

FIG. 16 shows a pixel configuration in that case. A gate line 1607 is selected to turn a selecting transistor 1601 on, and a signal is inputted from a signal line 1605 to a storage capacitor 1602. Then, a current flowing through a driving transistor 1603 is controlled in accordance with the signal, and a current flows from a first power supply line 1606 to a second power supply line 1608 through a display element 1604.

It is to be noted that in a signal writing period, potentials of the first power supply line 1606 and the second power supply line 1608 are controlled so that no voltage is applied to the display element 1604. As a result, the display element 1604 can be prevented from emitting light in a signal writing period.

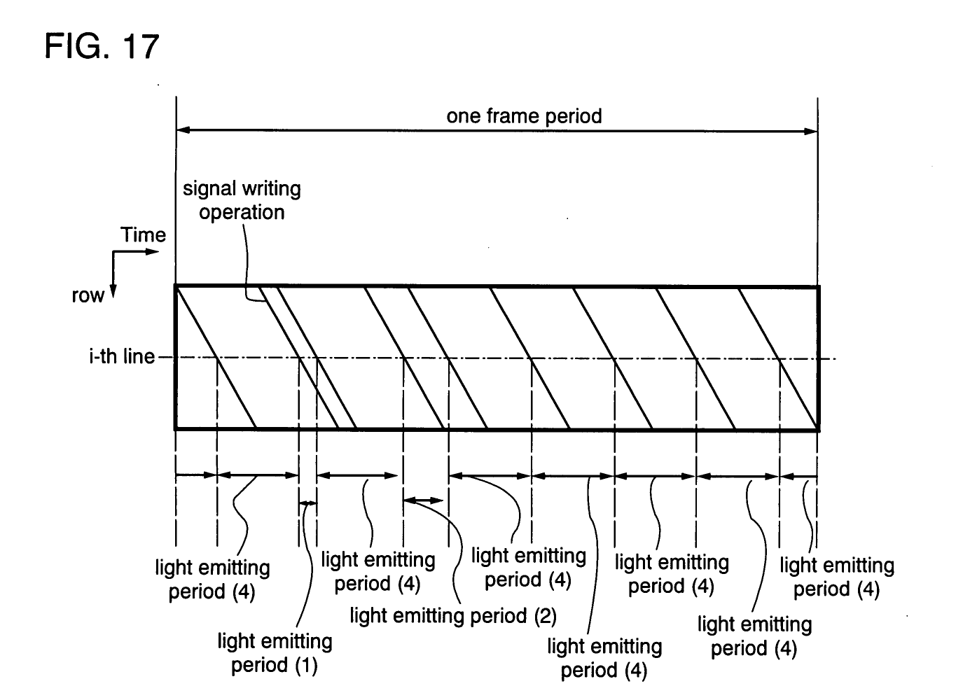

Subsequently, FIG. 17 shows a timing chart in the case where a period where a signal is written to a pixel and a period where light is emitted are not separated. Immediately after a signal is written to each row, a light emitting period starts.

In a certain row, after writing of signals and a predetermined light emitting period are completed, a signal writing operation starts in a subsequent subframe. By repeating such operations, the lengths of the light emitting periods are arranged in the order of 4, 1, 4, 2, 4, 4, 4, 4, and 4.

In this manner, many subframes can be arranged in one frame even if signals are written slowly.

Such a driving method is preferably applied to a plasma display. It is to be noted that in the case where the driving method is used for a plasma display, an initialization operation and the like are required, which are omitted here for simplicity.

Further, this driving method is also preferably applied to an organic EL display, a field emission display, a display using a Digital Micromirror Device (DMD), and the like.

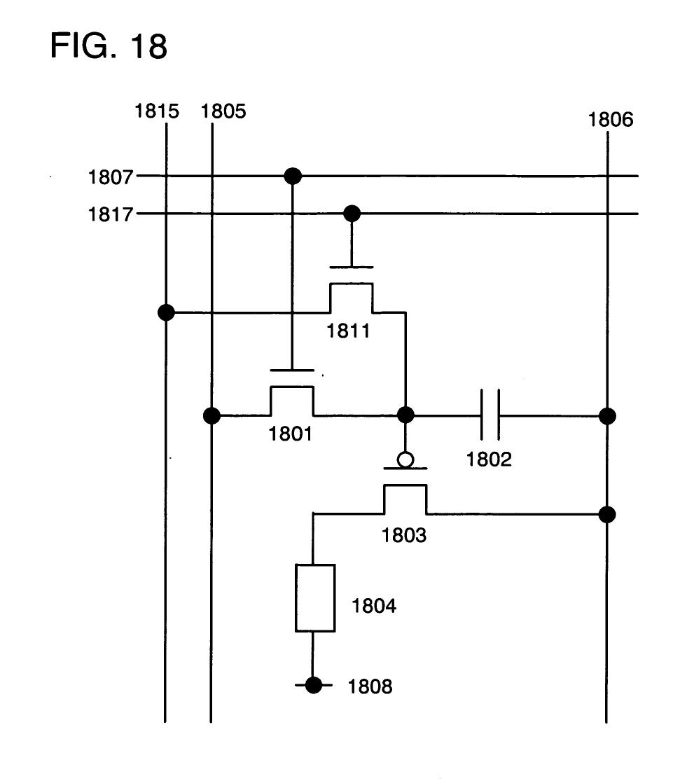

FIG. 18 shows a pixel configuration in that case. A first gate line 1807 is selected to turn a first selecting transistor 1801 on, and a signal is inputted from a first signal line 1805 to a storage capacitor 1802. Then, a current flowing through a driving transistor 1803 is controlled in accordance with the signal, and a current flows from a first power supply line 1806 to a second power supply line 1808 through a display element 1804. Similarly, a second gate line 1817 is selected to turn a second selecting transistor 1811 on, and a signal is inputted from a second signal line 1815 to the storage capacitor 1802. Then, a current flowing through the driving transistor 1803 is controlled in accordance with the signal, and a current flows from the first power supply line 1806 to the second power supply line 1808 through the display element 1804.

The first gate line 1807 and the second gate line 1817 can be controlled separately. Similarly, the first signal line 1805 and the second signal line 1815 can be controlled separately. Accordingly, signals can be inputted to pixels of two rows at the same time; thus the driving method as shown in FIG. 17 can be achieved.

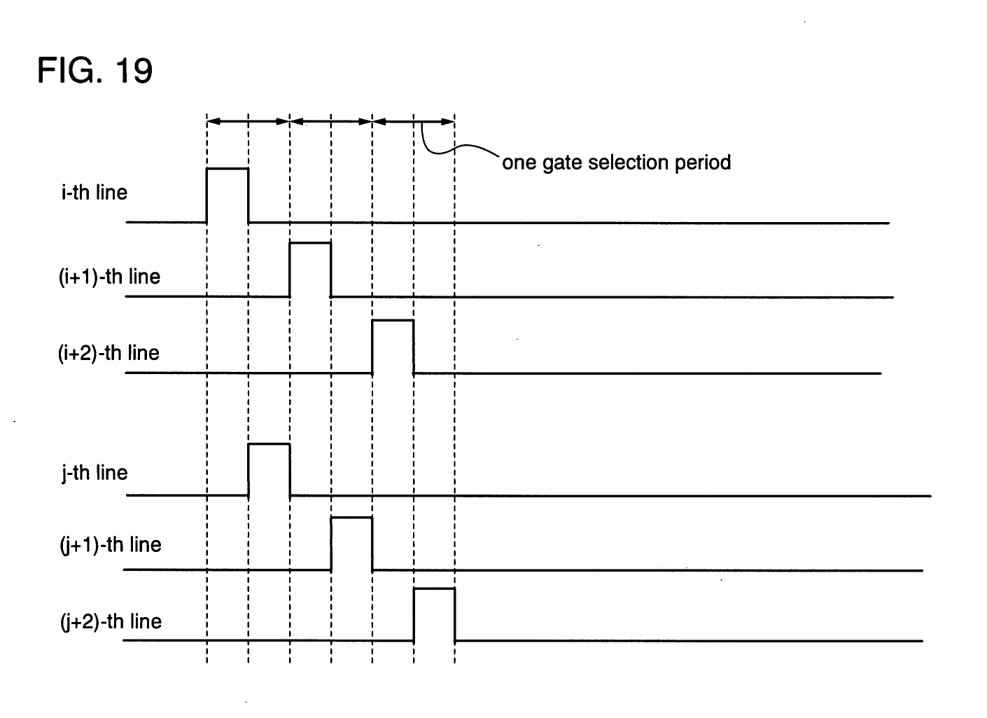

It is to be noted that the driving method as shown in FIG. 17 can also be achieved using the circuit of FIG. 16. FIG. 19 shows a timing chart of this case. As shown in FIG. 19, one gate selection period is divided into a plurality of periods (two in FIG. 19). Each gate line is selected in each of the divided selection periods and a corresponding signal is inputted to the first signal line 1805. For example, in one gate selection period, the i-th row is selected in the first half of the period and the j-th row is selected in the latter half of the period. Accordingly, an operation can be performed as if the two rows are selected at the same time in the one gate selection period.

It is to be noted that details of such a driving method are disclosed in, for example, Japanese Patent Laid-Open No. 2001-324958 and the like, which can be applied in combination with the invention.

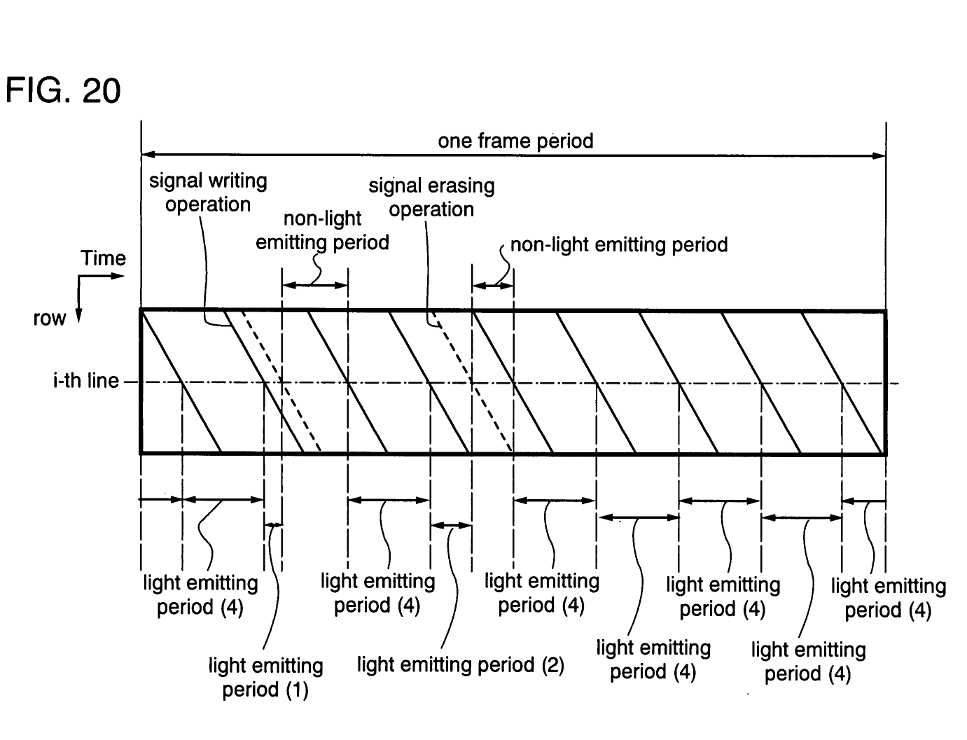

Subsequently, FIG. 20 shows a timing chart in the case where signals in pixels are erased. In each row, a signal writing operation is performed and the signals in the pixels are erased before a subsequent signal writing operation. According to this, the length of a light emitting period can easily be controlled.

In a certain row, after writing of signals and a predetermined light emitting period are completed, a signal writing operation starts in a subsequent subframe. In the case where a light emitting period is short, a signal erasing operation is performed to provide a non-light emitting state. By repeating such operations, the lengths of the light emitting periods are arranged in the order of 4, 1, 4, 2, 4, 4, 4, 4, and 4.

It is to be noted that although the signal erasing operation is performed in the case where the light emitting periods are 1 and 2 in FIG. 20, the invention is not limited to this. The erasing operation may be performed in other light emitting periods.

According to this, many subframes can be arranged in one frame even if signals are written slowly. Further, in the case of performing the signal erasing operation, data for erasing is not required to be obtained as well as a video signal; therefore, the driving frequency of a source driver can also be reduced.

Such a driving method is preferably applied to a plasma display. It is to be noted that in the case where the driving method is used for a plasma display, an initialization operation and the like are required, which are omitted here for simplicity.

Further, this driving method is also preferably applied to an organic EL display, a field emission display, a display using a Digital Micromirror Device (DMD), and the like.

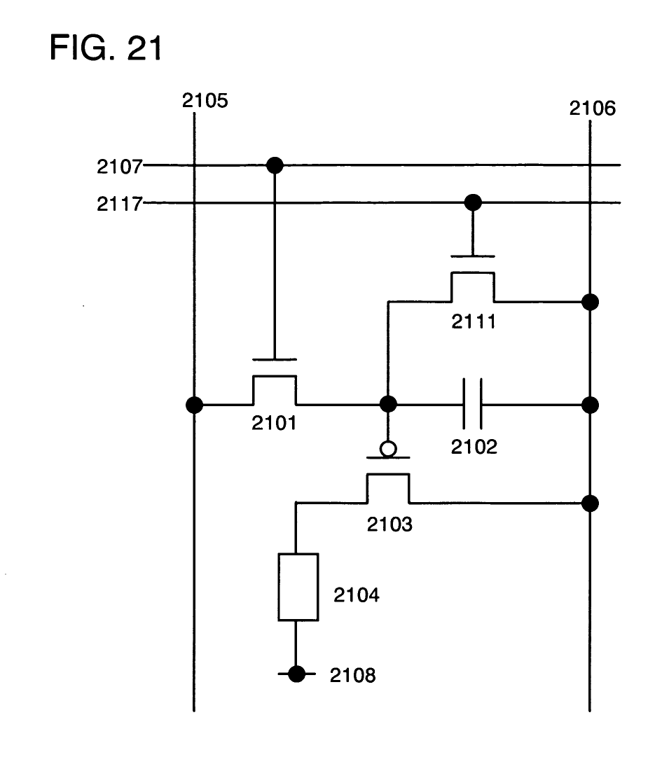

FIG. 21 shows a pixel configuration in that case. A first gate line 2107 is selected to turn a selecting transistor 2101 on, and a signal is inputted from a signal line 2105 to a storage capacitor 2102. Then, a current flowing through a driving transistor 2103 is controlled in accordance with the signal, and a current flows from a first power supply line 2106 to a second power supply line 2108 through a display element 2104.

In order to erase a signal, a second gate line 2117 is selected to turn an erasing transistor 2111 on, so that the driving transistor 2103 is turned off. Then, no current flows from the first power supply line 2106 to the second power supply line 2108 through the display element 2104. As a result, a non-light emitting period can be provided and the length of a light emitting period can be freely controlled.

Although the erasing transistor 2111 is used in FIG. 21, another method may be used. This is because a non-light emitting period may forcibly be provided so that no current is supplied to the display element 2104. Therefore, a non-light emitting period may be provided by arranging a switch somewhere in a path where a current flows from the first power supply line 2106 to the second power supply line 2108 through the display element 2104 and controlling on/off of the switch. Alternatively, a gate-source voltage of the driving transistor 2103 may be controlled to forcibly turn the driving transistor off.

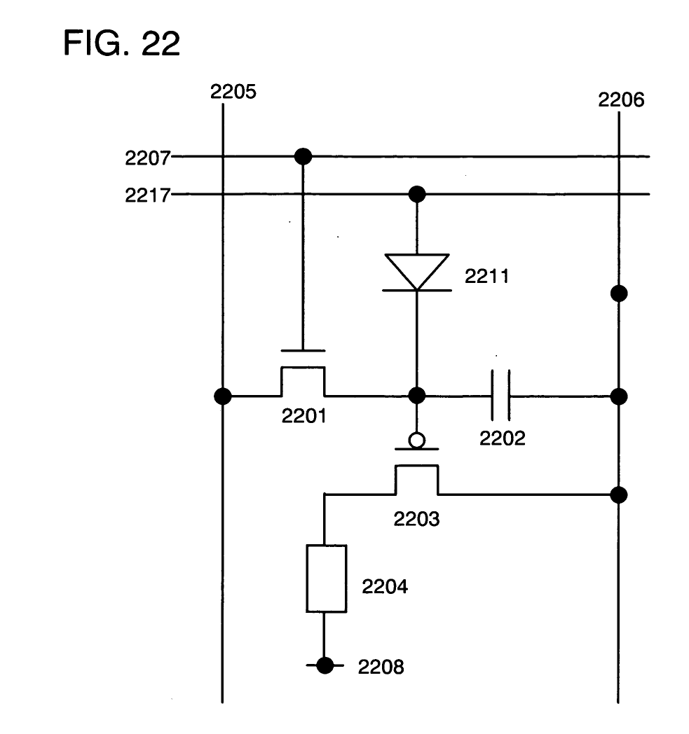

FIG. 22 shows an example of a pixel configuration in the case where a driving transistor is forcibly turned off. A selecting transistor 2201, a driving transistor 2203, an erasing diode 2211, and a display element 2204 are provided. A source and a drain of the selecting transistor 2201 are connected to a signal line 2205 and a gate of the driving transistor 2203. A gate of the selecting transistor 2201 is connected to the first gate line 2107. A source and a drain of the driving transistor 2203 are connected to a first power supply line 2206 and the display element 2204. The erasing diode 2211 is connected to the gate of the driving transistor 2203 and a second gate line 2217.

A storage capacitor 2202 has a function of holding a gate potential of the driving transistor 2203. Thus, although the storage capacitor 2202 is connected between the gate of the driving transistor 2203 and the first power supply line 2206, the invention is not limited to this. The storage capacitor 2202 may be arranged to hold the gate potential of the driving transistor 2203. Further, in the case where the gate potential of the driving transistor 2203 can be held using the gate capacitance of the driving transistor 2203, and the like, the storage capacitor 2202 may be omitted.

As an operating method, the first gate line 2207 is selected to turn the selecting transistor 2201 on, and a signal is inputted from the signal line 2205 to the storage capacitor 2202. Then, a current flowing through the driving transistor 2203 is controlled in accordance with the signal, and a current flows from the first power supply line 2106 to a second power supply line 2108 through the display element 2104.

In order to erase a signal, the second gate line 2117 is selected (supplied with a high potential here) to turn the erasing diode 2211 on, so that a current flows from the second gate line 2117 to the gate of the driving transistor 2203. As a result, the driving transistor 2203 is turned off. Then, no current flows from the first power supply line 2206 to the second power supply line 2208 through the display element 2204. As a result, a non-light emitting period can be provided and the length of a light emitting period can be freely controlled.

In order to hold a signal, the second gate line 2117 is not selected (supplied with a low potential here). Then, the erasing diode 2211 is turned off and the gate potential of the driving transistor 2203 is thus held.

It is to be noted that the erasing diode 2211 may be any element as far as it has rectifying properties. It may be a PN diode, a PIN diode, a Schottky diode, or a zener diode.

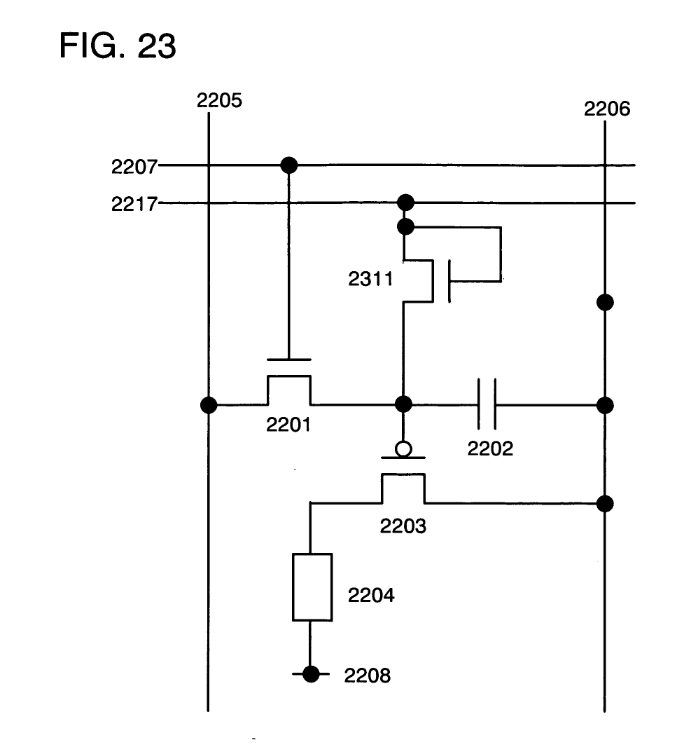

Further, a diode-connected transistor (a gate and a drain thereof are connected) may be used as well. A circuit diagram in this case is shown in FIG. 23. As the erasing diode 2211, a diode-connected transistor 2311 is used. Although an N-channel transistor is used here, the invention is not limited to this and a P-channel transistor may be used.

It is to be noted that a driving method as shown in FIG. 20 can be achieved using the circuit in FIG. 16 as still another circuit. FIG. 19 shows a timing chart of this case. As shown in FIG. 19, one gate selection period is divided into a plurality of periods (two in FIG. 19). Each gate line is selected in each of the divided selection periods and a corresponding signal (a video signal and an erasing signal) is inputted to the first signal line 1805. For example, in one gate selection period, the i-th row is selected in the first half of the period and the j-th row is selected in the latter half of the period. Then, when the i-th row is selected, a video signal for it is inputted. On the other hand, when the j-th row is selected, a signal for turning the driving transistor off is inputted. Accordingly, an operation can be performed as if the two rows are selected at the same time in the one gate selection period.

It is to be noted that details of such a driving method are disclosed in, for example, Japanese Patent Laid-Open No. 2001-324958 and the like, which can be applied in combination with the invention.

It is to be noted that the timing charts, pixel configurations, and driving methods that are shown in this embodiment mode are examples and the invention is not limited to these. The invention can be applied to various timing charts, pixel configurations, and driving methods.

It is to be noted that the order in which subframes appear may be changed depending on time. For example, the order in which subframes appear may be changed between the first frame and the second frame. Further, the order in which subframes appear may be changed depending on place. For example, the order in which subframes appear may be changed between the pixel A and the pixel B. Further, the order in which subframes appear may be changed depending on time and place by combining these.

It is to be noted that a light emitting period, a signal writing period, and a non-light emitting period are arranged in one frame period in this embodiment mode; however, the invention is not limited to this and other operation periods may also be arranged. For example, a period where a voltage of opposite polarity to normal polarity is applied to a display element, a so-called reverse bias period may be provided. By providing the reverse bias period, the reliability of the display element is improved in some cases.

It is to be noted that the invention is not limited to the pixel configurations described in this embodiment mode. Other configurations having the same function can be applied as well.

It is to be noted that the details described in this embodiment mode can be implemented by freely combining with the details described in Embodiment Modes 1 and 2.

### Embodiment Mode 3

In this embodiment mode, description is made on an example of the number of bits allocated to the overlapping time gray scale method and the binary code time gray scale method in the case of expressing a certain gray scale level.

First, a case of expressing 6 bits (64 gray scales) is considered. As an example, high-order 4 bits (16 gray scales) using the overlapping time gray scale method are expressed using 15 subframes, and low-order 2 bits (4 gray scales) using the binary code time gray scale method are expressed using at least 2 subframes. The number of subframes according to the binary code time gray scale method may be increased by dividing the high-order bits and the like. As a result, 17 subframes are provided in total.

As another example, high-order 3 bits (8 gray scales) using the overlapping time gray scale method are expressed using 7 subframes, and low-order 3 bits (8 gray scales) using the binary code time gray scale method are expressed using at least 3 subframes. The number of subframes according to the binary code time gray scale method may be increased by diving the high-order bits and the like. As a result, 10 subframes are provided in total.

As another example, high-order 6 gray scales using the overlapping time gray scale method are expressed using 5 subframes, and low-order 4 bits (16 gray scales) using the binary code time gray scale method are expressed using at least 4 subframes. The number of subframes according to the binary code time gray scale method may be increased by diving the high-order bits and the like. It is to be noted that a larger number of gray scale levels than that used actually can be expressed in this case, which does not matter. As a result, 9 subframes are provided in total.

As another example, high-order 2 bits (4 gray scales) using the overlapping time gray scale method are expressed using 3 subframes, and low-order 4 bits (16 gray scales) using the binary code time gray scale method are expressed using at least 4 subframes. The number of subframes according to the binary code time gray scale method may be increased by diving the high-order bits and the like. As a result, 7 subframes are provided in total.

Next, a case of expressing 8 bits (256 gray scales) is considered. As an example, high-order 5 bits (32 gray scales) using the overlapping time gray scale method are expressed using 31 subframes, and low-order 3 bits (8 gray scales) using the binary code time gray scale method are expressed using at least 3 subframes. The number of subframes according to the binary code time gray scale method may be increased by diving the high-order bits and the like. As a result, 34 subframes are provided in total.

As another example, high-order 4 bits (16 gray scales) using the overlapping time gray scale method are expressed using 15 subframes, and low-order 4 bits (16 gray scales) using the binary code time gray scale method are expressed using at least 4 subframes. The number of subframes according to the binary code time gray scale method may be increased by diving the high-order bits and the like. As a result, 19 subframes are provided in total.

As another example, high-order 3 bits (8 gray scales) using the overlapping time gray scale method are expressed using 7 subframes, and low-order 5 bits (32 gray scales) using the binary code time gray scale method are expressed using at least 5 subframes. The number of subframes according to the binary code time gray scale method may be increased by diving the high-order bits and the like. As a result, 12 subframes are provided in total.

As another example, high-order 2 bits (4 gray scales) using the overlapping time gray scale method are expressed using 3 subframes, and low-order 6 bits (64 gray scales) using the binary code time gray scale method are expressed using at least 6 subframes. The number of subframes according to the binary code time gray scale method may be increased by diving the high-order bits and the like. As a result, 9 subframes are provided in total.

Thus, when the case where n-bit gray scales are expressed is considered, in general, high-order m bits using the overlapping time gray scale method are expressed using (2^{m}−1) subframes, whereas low-order p bits using the binary code time gray scale method are expressed using at least p subframes. The number of subframes may be increased by dividing the high-order bits and the like. As a result, at least (2^{m}−1+p) subframes are required in total.

It is to be noted that the details described in this embodiment mode can be implemented by freely combining with the details described in Embodiment Modes 1 and 2.

### Embodiment Mode 4

In this embodiment mode, an example of a display device using a driving method of the invention is described.

As the most typical display device, a plasma display can be given. A pixel of a plasma display can be only in a light emitting state or a non-light emitting state. Accordingly, a time gray scale method is used as one of the means for achieving multiple gray scales. Therefore, the invention can be applied thereto.

It is to be noted that in a plasma display, initialization of a pixel is required as well as writing of a signal to a pixel. Therefore, it is desirable that subframes be arranged in order in the portion where the overlapping time gray scale method is used, and subframes using the binary code time gray scale method not be sandwiched therebetween. By thus arranging the subframes, the number of times of initialization of a pixel can be reduced. As a result, the contrast can be improved.

When subframes using the binary code time gray scale method are arranged together, however, this portion causes pseudo contours. Accordingly, subframes using the binary code time gray scale method are desirably arranged as separately as possible in one frame. In the case of using subframes using the binary code time gray scale method, initialization is required to be performed corresponding to each subframe. Therefore, it is not a major problem that subframes using the binary code time gray scale method are arranged separately. On the other hand, in the case of subframes using the overlapping time gray scale method, initialization is not required if subframes where light is emitted are arranged in series. Thus, the subframes are desirably arranged as orderly as possible.

Accordingly, as the order in which subframes appear, subframes using the overlapping time gray scale method are desirably arranged so that subframes where light is emitted are arranged in series, and subframes using the binary code time gray scale method are desirably arranged separately between the subframes using the overlapping time gray scale method. According to this, the number of times of initialization can be reduced, the contrast can be improved, and pseudo contours can be reduced.

As examples of a display device other than a plasma display, an organic EL display, a field emission display, a display using a Digital Micromirror Device (DMD), a ferroelectric liquid crystal display, a bistable liquid crystal display, and the like are given. All of them are display devices to which the time gray scale method can be applied. Pseudo contours can be reduced by applying the time gray scale method to these display devices.

For example, in the case of an organic EL display, an operation such as initialization of a pixel is not required unlike a plasma display. Therefore, reduction in contrast, which is caused by light emission in an operation such as initialization of a pixel, does not occur. Accordingly, the order in which subframes appear can be set arbitrarily. Subframes are desirably arranged at random so as to reduce pseudo contours as much as possible.

Therefore, subframes using the overlapping time gray scale method may be arranged so that subframes where light is emitted are arranged in series, and subframes using the binary code time gray scale method may be separately arranged between the subframes using the overlapping time gray scale method. According to this, the subframes using the overlapping time gray scale method are arranged together in one frame to some degree, thereby pseudo contours are prevented from occurring in a boundary between the first frame and the second frame. So-called moving image pseudo contours can be reduced. Further, since the subframes using the binary code time gray scale method are separately arranged, pseudo contours can be reduced.

Alternatively, subframes using the overlapping time gray scale method may be arranged at random, and subframes using the binary code time gray scale method may also be arranged at random. As a result, pseudo contours caused by the portions using the binary code time gray scale method are mixed with the subframes using the overlapping gray scale method; therefore, the effect of reducing pseudo contours increases as a whole.

It is to be noted that the details described in this embodiment mode can be implemented by freely combining with the details described in Embodiment Modes 1 to 3.

### Embodiment Mode 5

In this embodiment mode below, a configuration and an operation of a display device, a signal line driver circuit, and a gate line driver circuit are described.

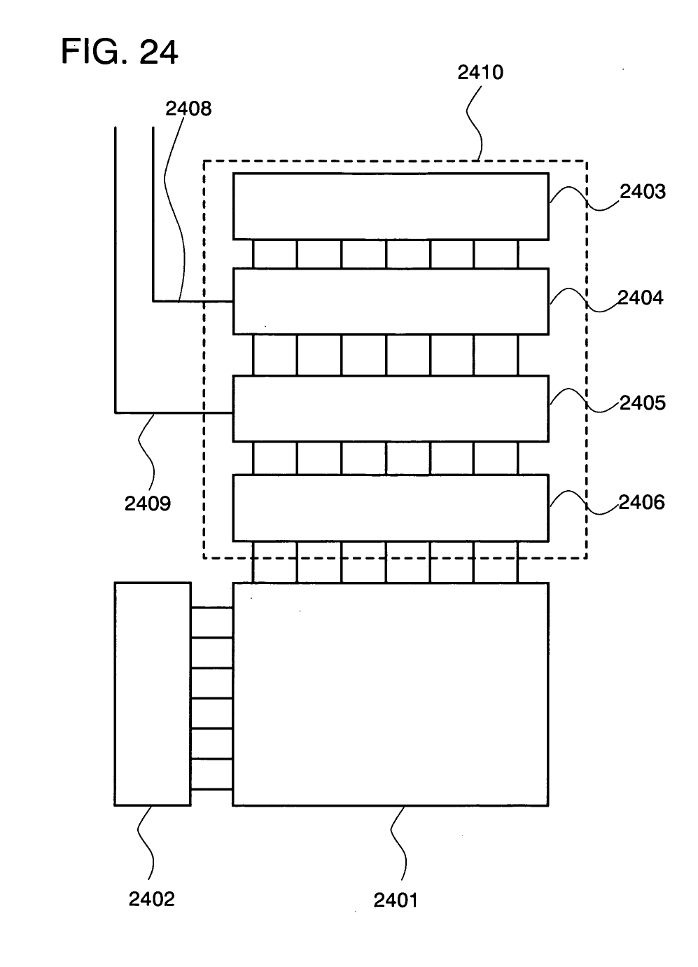

As shown in FIG. 24, a display device has a pixel array 2401, a gate line driver circuit 2402, and a signal line driver circuit 2410. The gate line driver circuit 2402 sequentially outputs a selection signal to the pixel array 2401. The gate line driver circuit 2402 is constituted by a shift register, a buffer circuit, and the like.

Besides, the gate line driver circuit 2402 often includes a level shifter circuit, a pulse width controlling circuit, and the like. The shift resister outputs a pulse to select sequentially. The signal line driver circuit 2410 sequentially outputs a video signal to the pixel array 2401. The shift resister 2403 outputs a pulse to select sequentially. In the pixel array 2401, images are displayed by controlling a state of light in accordance with the video signal. The video signal inputted from the signal line driver circuit 2410 to the pixel array 2401 is often a voltage. That is to say, states of a display element arranged in each pixel and an element controlling the display element are changed by the video signal (voltage) inputted from the signal line driver circuit 2410. As examples of a display element arranged in a pixel, an EL element, an element used for an FED (Field Emission Display), a liquid crystal, a DMD (Digital Micromirror Device), and the like can be given.

It is to be noted that the gate line driver circuit 2402 and the signal line driver circuit 2410 may be arranged in plural.

The configuration of the signal line driver circuit 2410 can be divided into plural portions. As an example, the signal line driver circuit 2410 can be roughly divided into a shift register 2403, a first latch circuit (LAT1) 2404, a second latch circuit (LAT2) 2405, and an amplifier circuit 2406. The amplifier circuit 2406 may have a function of converting a digital signal into an analog signal and a function of performing a gamma correction.

In addition, a pixel has a display element such as an EL element. A circuit for outputting current (video signal) to the display element, namely, a current source circuit may be provided in some cases.

Thus, an operation of the signal line driver circuit 2410 is briefly described. A clock signal (S-CLK), a start pulse (SP), and an inverted clock signal (S-CLKb) are inputted to the shift resister 2403, and a sampling pulse is sequentially outputted in accordance with the timing of these signals.

The sampling pulse outputted from the shift register 2403 is inputted to the first latch circuit (LAT1) 2404. A video signal is inputted from a video signal line 2408 to the first latch circuit (LAT1) 2404. The first latch circuit (LAT1) 2404 holds a video signal of each column in accordance with the timing at which the sampling pulse is inputted.

After holding of video signals is completed to the last column in the first latch circuit (LAT1) 2404, a latch pulse (Latch Pulse) is inputted from a latch control line 2409 during a horizontal retrace period, and the video signals held in the first latch circuit (LAT1) 2404 are transferred to the second latch circuit (LAT2) 2405 at once. After that, the video signals of one row, which are held in the second latch circuit (LAT2) 2405, are inputted to the amplifier circuit 2406 at once. A signal outputted from the amplifier circuit 2406 is inputted to the pixel array 2401.

While the video signal held in the second latch circuit (LAT2) 2405 is inputted to the amplifier circuit 2406 and then inputted to the pixel array 2401, a sampling pulse is outputted from the shift register 2403 again. That is to say, two operations are performed at the same time. According to this, a line sequential driving can be enabled. These operations are repeated thereafter.

It is to be noted that the signal line driver circuit or a portion thereof (the current source circuit, the amplifier circuit, and the like) may be constituted using, for example, an external IC chip in some cases instead of being provided over the same substrate as the pixel array 2401.

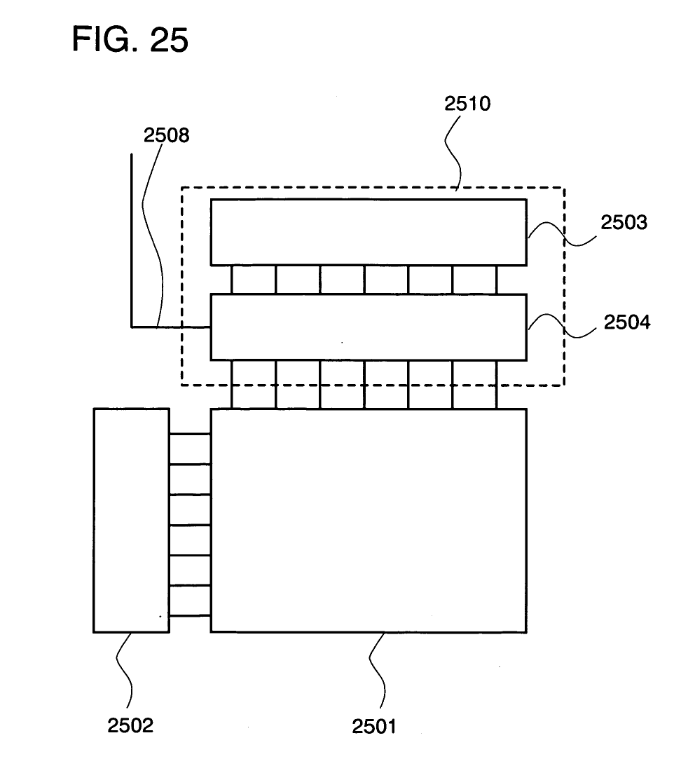

It is to be noted that the configuration of the signal line driver circuit, the gate line driver circuit, and the like is not limited to that in FIG. 24. For example, a signal is supplied to a pixel by a dot sequential driving in some cases. FIG. 25 shows an example of a signal line driver circuit 2510 in that case. A sampling pulse is outputted from a shift resister 2503 to a sampling circuit 2504. A video signal is inputted from a video signal line 2508 and the video signal is outputted to a pixel array 2501 in accordance with the sampling pulse. In addition, a gate line driver circuit 2502 sequentially outputs a selection signal to the pixel array 2501.

It is to be noted that, as described above, a transistor of the invention may be any type of transistor, and formed over any substrate. Therefore, the circuits shown in FIGS. 24 and 25 may all be formed over a glass substrate, a plastic substrate, a single crystalline substrate, an SOI substrate, or any substrate. Alternatively, a portion of the circuits in FIGS. 24 and 25 may be formed over one substrate, and the other portion of the circuits in FIGS. 24 and 25 may be formed over another substrate. That is to say, the whole circuits in FIGS. 24 and 25 are not necessarily formed over the same substrate. For example, in FIGS. 24 and 25, the pixel array 2401 and the gate line driver circuit 2402 may be formed over a glass substrate using TFTs, and the signal line driver circuit 2410 (or a portion thereof) may be formed over a single crystalline substrate, and then an IC chip thereof may be connected by COG (Chip On Glass) to be provided over a glass substrate. Alternatively, the IC chip may be connected to the glass substrate by TAB (Tape Auto Bonding) or using a printed substrate.

It is to be noted that the details described in this embodiment mode utilize the details described in Embodiment Modes 1 to 4. Therefore, the details described in Embodiment Modes 1 to 4 can be applied to this embodiment mode.

### Embodiment Mode 6

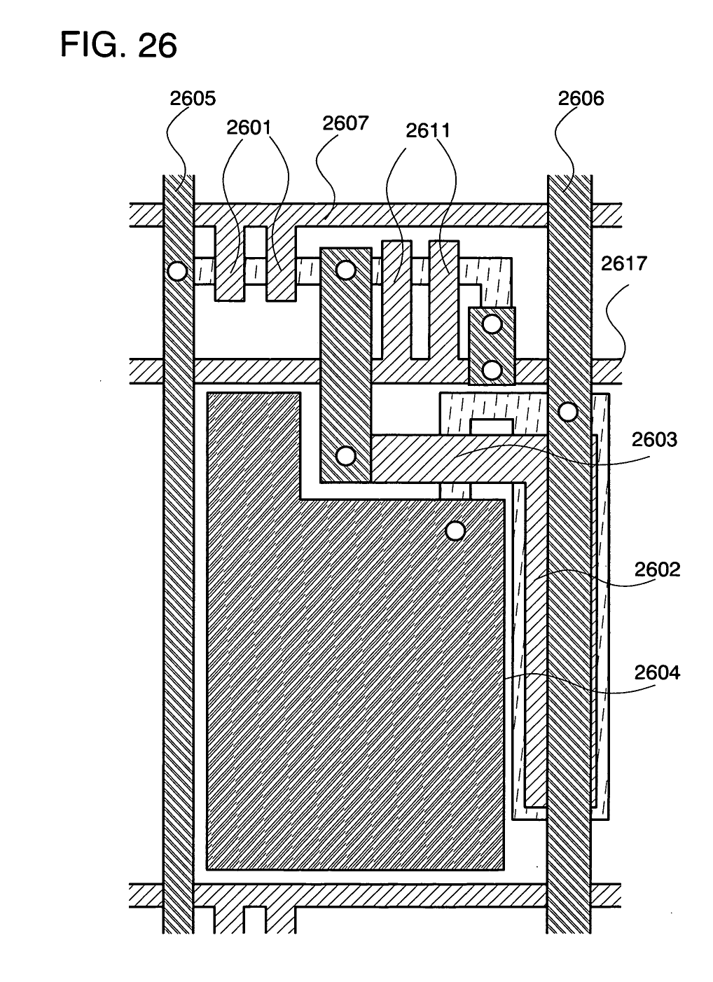

Next, a layout of a pixel in a display device of the invention is described. As an example, a layout diagram of the circuit diagram shown in FIG. 23 is shown in FIG. 26. It is to be noted that the circuit diagram and the layout diagram are not limited to FIG. 23 and FIG. 26.

A selecting transistor 2601, a driving transistor 2603, a diode-connected transistor 2611, and a display element 2604 as a display element are provided. A source and a drain of the selecting transistor 2601 are connected to a signal line 2605 and a gate of the driving transistor 2603. A gate of the selecting transistor 2601 is connected to the first gate line 2107. A source and a drain of the driving transistor 2603 are connected to a power supply line 2606 and the display element 2604. The diode-connected transistor 2611 is connected to the gate of the driving transistor 2603 and a second gate line 2617. A storage capacitor 2602 is connected between the gate of the driving transistor 2603 and the power supply line 2606.

The signal line 2605 and the power supply line 2606 are formed of a second wire, whereas the first gate line 2607 and the second gate line 2617 are formed of a first wire.

In the case of a top gate structure, films are formed in the order of a substrate, a semiconductor layer, a gate insulating film, a first wire, an interlayer insulating film, and a second wire. In the case of a bottom gate structure, films are formed in the order of a substrate, a first wire, a gate insulating film, a semiconductor layer, an interlayer insulating film, and a second wire.

It is to be noted that the details described in this embodiment mode can be implemented by freely combining with the details described in Embodiment Modes 1 to 5.

### Embodiment Mode 7

Described in this embodiment mode is hardware for controlling the driving method described in Embodiment Modes 1 to 6.

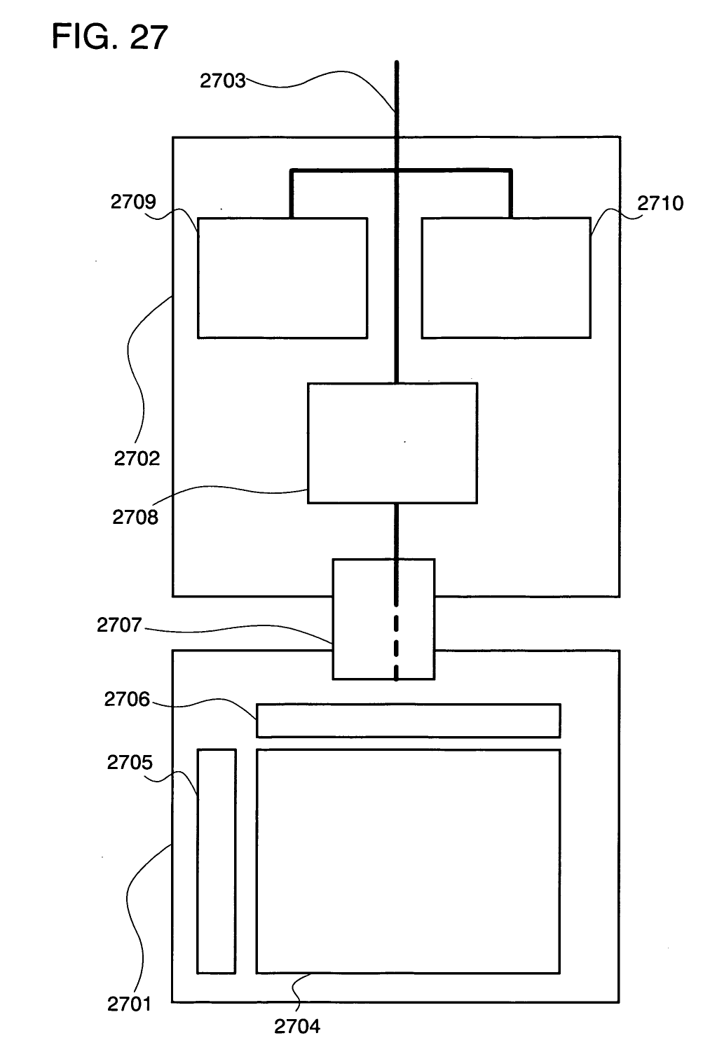

A general configuration diagram is shown in FIG. 27. A pixel array 2704 is provided over a substrate 2701. A signal line driver circuit 2706 and a gate line driver circuit 2705 are provided in many cases. Besides, a power supply circuit, a precharge circuit, a timing generating circuit, and the like may be provided. There are some cases where the signal line driver circuit 2706 and the gate line driver circuit 2705 are not provided. In that case, circuits that are not provided over the substrate 2701 are formed as an IC in many cases. The IC is provided over the substrate 2701 by COG (Chip On Glass) in many cases. Alternatively, the IC may be provided over a connecting substrate 2707 that connects the substrate 2701 to a peripheral circuit substrate 2702.

A signal 2703 is inputted to the peripheral circuit substrate 2702. Then, the signal is held in a memory 2709, a memory 2710 and the like by the control of a controller 2708. In the case where the signal 2703 is an analog signal, it is often analog-to-digital converted to be held in the memory 2709, the memory 2710 and the like. Then, the controller 2708 outputs a signal to the substrate 2701 using the signal held in the memory 2709, the memory 2710 and the like.

In order to achieve the driving method described in Embodiment Mode 1 to Embodiment Mode 6, the controller 2708 outputs a signal to the substrate 2701 by controlling the order in which subframes appear, and the like.

It is to be noted that the details described in this embodiment mode can be implemented by freely combining with the details described in Embodiment Modes 1 to 6.

### Embodiment Mode 8

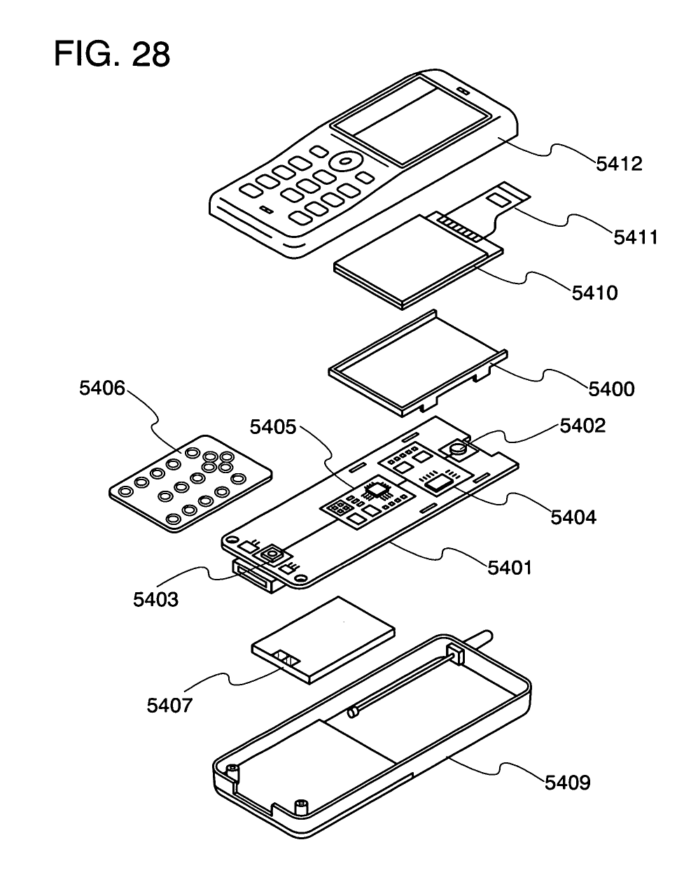

A configuration example of a mobile phone having a display portion that is formed using a display device of the invention or a display device using a driving method thereof is described with reference to FIG. 28.

A display panel 5410 is incorporated in a housing 5400 such that it can be freely attached and detached. The shape and size of the housing 5400 can be changed appropriately in accordance with the size of the display panel 5410. The housing 5400 to which the display panel 5410 is fixed is fitted in a printed substrate 5401 so that it is constructed as a module.

The display panel 5410 is connected to the printed substrate 5401 through an FPC 5411. A signal processing circuit 5405 including a speaker 5402, a microphone 5403, a transmitting/receiving circuit 5404, a CPU, a controller, and the like is mounted on the printed substrate 5401. Such a module, an input means 5406, and a battery 5407 are combined to be incorporated in housings 5409 and 5412. A pixel portion of the display panel 5410 is arranged to be seen from an opening window of the housing 5409.

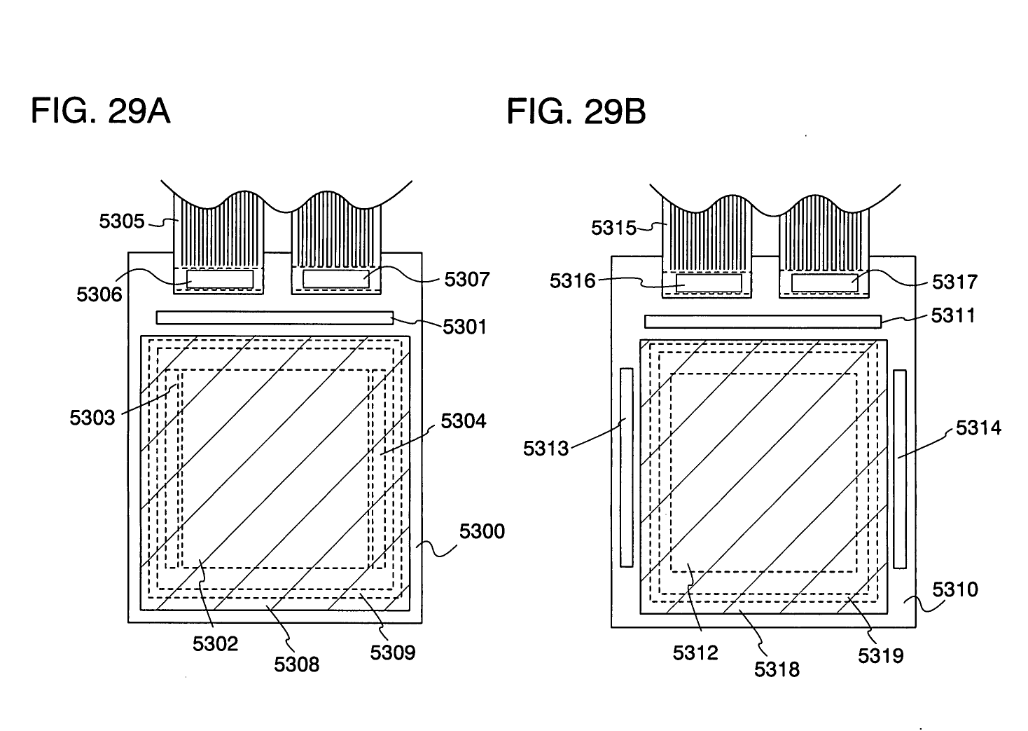

In the display panel 5410, a pixel portion and a portion of peripheral driver circuits (a driver circuit with a lower operating frequency among a plurality of driver circuits) may be integrated over a substrate using TFTs, and another portion of the peripheral driver circuits (a driver circuit with a higher operating frequency among the plurality of driver circuits) may be formed over an IC chip, and then the IC chip may be mounted on the display panel 5410 by COG (Chip On Glass). Alternatively, the IC chip may be connected to a glass substrate by TAB (Tape Auto Bonding) or using a printed substrate. It is to be noted that FIG. 29A shows an example of a configuration of a display panel where a portion of peripheral driver circuits and a pixel portion are integrated over a substrate and an IC chip including the other peripheral driver circuits is mounted by COG or the like. It is to be noted that a configuration of the display panel in FIG. 29A has a substrate 5300, a signal line driver circuit 5301, a pixel portion 5302, a scan line driver circuit 5303, a scan line driver circuit 5304, an FPC 5305, an IC chip 5306, an IC chip 5307, a sealing substrate 5308, and a sealing member 5309. By employing such a configuration, the power consumption of a display device can be lowered and the operating time of a mobile phone by charging once can be extended. In addition, the cost of a mobile phone can be reduced.

Further, when a signal that is set for a scan line or a signal line is impedance-converted by a buffer, a writing period of one row of pixels can be reduced. Therefore, a display device with higher definition can be provided.

Further, in order to further reduce the power consumption, as shown in FIG. 29B, a pixel portion may be formed over a substrate using TFTs, peripheral driver circuits may all be formed over an IC chip, and then the IC chip may be mounted on a display panel by COG (Chip On Glass) or the like. It is to be noted that a configuration of a display panel in FIG. 29B has a substrate 5310, a signal line driver circuit 5311, a pixel portion 5312, a scan line driver circuit 5313, a scan line driver circuit 5314, an FPC 5315, an IC chip 5316, an IC chip 5317, a sealing substrate 5318, and a sealing member 5319.

By using the display device of the invention and the driving method thereof, a clear image where pseudo contours are reduced can be displayed. Therefore, an image with gray scales that subtly change, such as human skin, can be displayed clearly.

In addition, the configuration shown in this embodiment is an example of a mobile phone, and the display device of the invention is not limited to a mobile phone with such a configuration and can be applied to a mobile phone with various configurations.

### Embodiment Mode 9

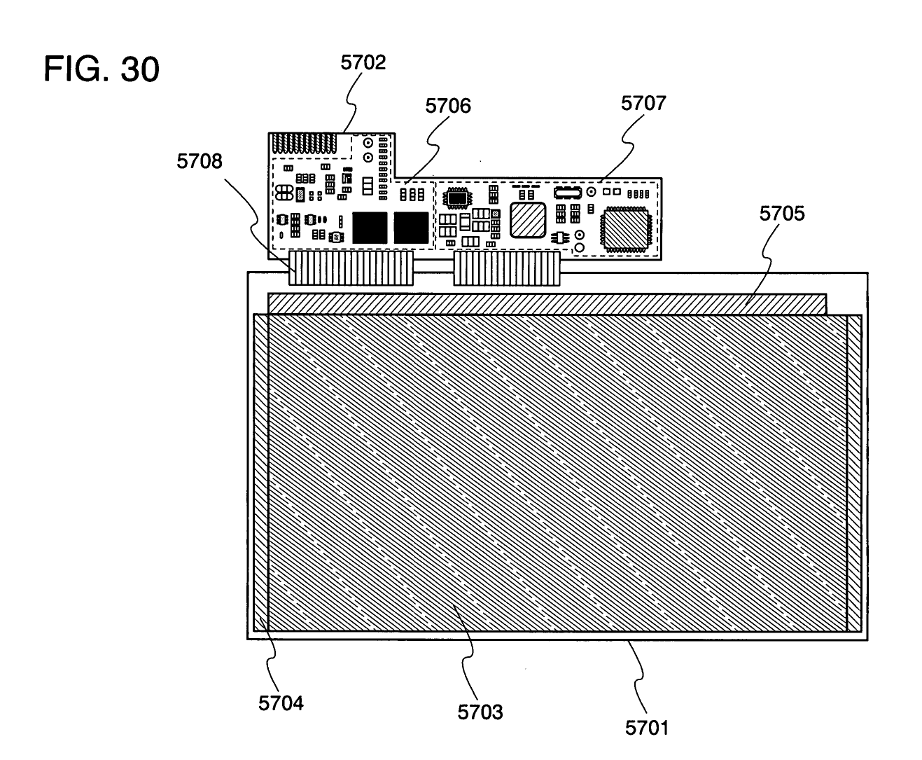

FIG. 30 shows an EL module where a display panel 5701 and a circuit substrate 5702 are combined. The display panel 5701 has a pixel portion 5703, a scan line driver circuit 5704, and a signal line driver circuit 5705. The circuit substrate 5702 includes, for example, a control circuit 5706, a signal division circuit 5707, and the like. The display panel 5701 is connected to the circuit substrate 5702 with a connecting wire 5708. As the connecting wire, an FPC and the like may be employed.

The control circuit 5706 corresponds to the controller 2708, the memory 2709, the memory 2710, and the like, which are shown in Embodiment Mode 7. The order in which subframes appear, and the like are controlled mainly by the control circuit 5706.

In the display panel 5701, a pixel portion and a portion of peripheral driver circuits (a driver circuit with a lower operating frequency among a plurality of driver circuits) may be integrated over a substrate using TFTs, and another portion of the peripheral driver circuits (a driver circuit with a higher operating frequency among the plurality of driver circuits) may be formed over an IC chip, and then the IC chip may be mounted on the display panel 5701 by COG (Chip On Glass) or the like. Alternatively, the IC chip may be mounted on the display panel 5701 by TAB (Tape Auto Bonding) or using a printed substrate. It is to be noted that FIG. 29A shows a configuration example where a portion of peripheral driver circuits and a pixel portion are integrated over a substrate and an IC chip including the other peripheral driver circuits is mounted by COG or the like. By employing such a configuration, the power consumption of a display device can be lowered and the operating time of a mobile phone by charging once can be extended. In addition, the cost of a mobile phone can be reduced.

Further, when a signal that is set for a scan line or a signal line is impedance-converted by a buffer, a writing period of one row of pixels can be reduced. Therefore, a display device with higher definition can be provided.

Further, in order to further reduce the power consumption, a pixel portion may be formed over a glass substrate using TFTs, signal line driver circuits may all be formed over an IC chip, and then the IC chip may be mounted on a display panel by COG (Chip On Glass).

It is to be noted that a pixel portion may be formed over a substrate using TFTs, peripheral driver circuits may all be formed over an IC chip, and then the IC chip may be mounted on a display panel by COG (Chip On Glass). It is to be noted that FIG. 29B shows a configuration example where a pixel portion is formed over a substrate and an IC chip including a signal line driver circuit is formed over the same substrate by COG or the like.

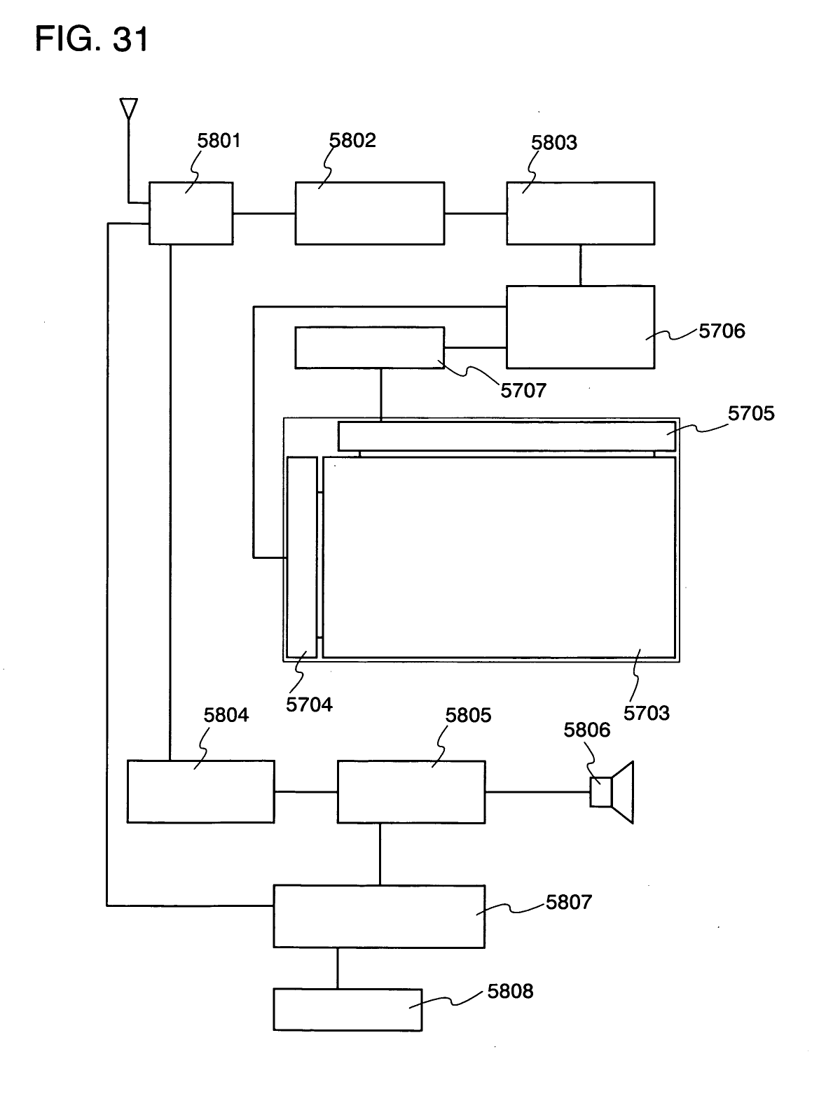

An EL television receiver can be completed using this EL module. FIG. 31 is a block diagram showing a main configuration of an EL television receiver. A tuner 5801 receives a video signal and an audio signal. The video signal is processed by a video signal amplifier circuit 5802, a video signal processing circuit 5803 for converting the signal outputted from the video signal amplifier circuit 5802 into a color signal corresponding to each of red, green, and blue, and the control circuit 5706 for converting the video signal into input specifications to a driver circuit. The control circuit 5706 outputs a signal to each of a scan line side and a signal line side. In the case of a digital driving, the signal division circuit 5707 may be provided at the signal line side so that an input digital signal is divided into m signals to be supplied.

An audio signal among signals received by the tuner 5801 is transmitted to an audio signal amplifier circuit 5804 and the output thereof is supplied to a speaker 5806 through an audio signal processing circuit 5805. A control circuit 5807 receives control data such as a receiving station (reception frequency) and a volume from an input portion 5808, and sends out a signal to the tuner 5801 and the audio signal processing circuit 5805.

A television receiver can be completed by incorporating the EL module in a housing. The EL module constitutes a display portion. In addition, a speaker, a video input terminal, and the like are provided appropriately.

It is needless to say that the invention can be applied not only to a television receiver but to various applications such as a monitor of a personal computer and particularly large area display media typified by an information display panel at train stations, airports and the like, and an advertising display panel on the streets.

In this manner, by using the display device of the invention and the driving method thereof, a clear image where pseudo contours are reduced can be displayed. Therefore, an image with gray scales that subtly change, such as human skin, can be displayed clearly.

### Embodiment Mode 10

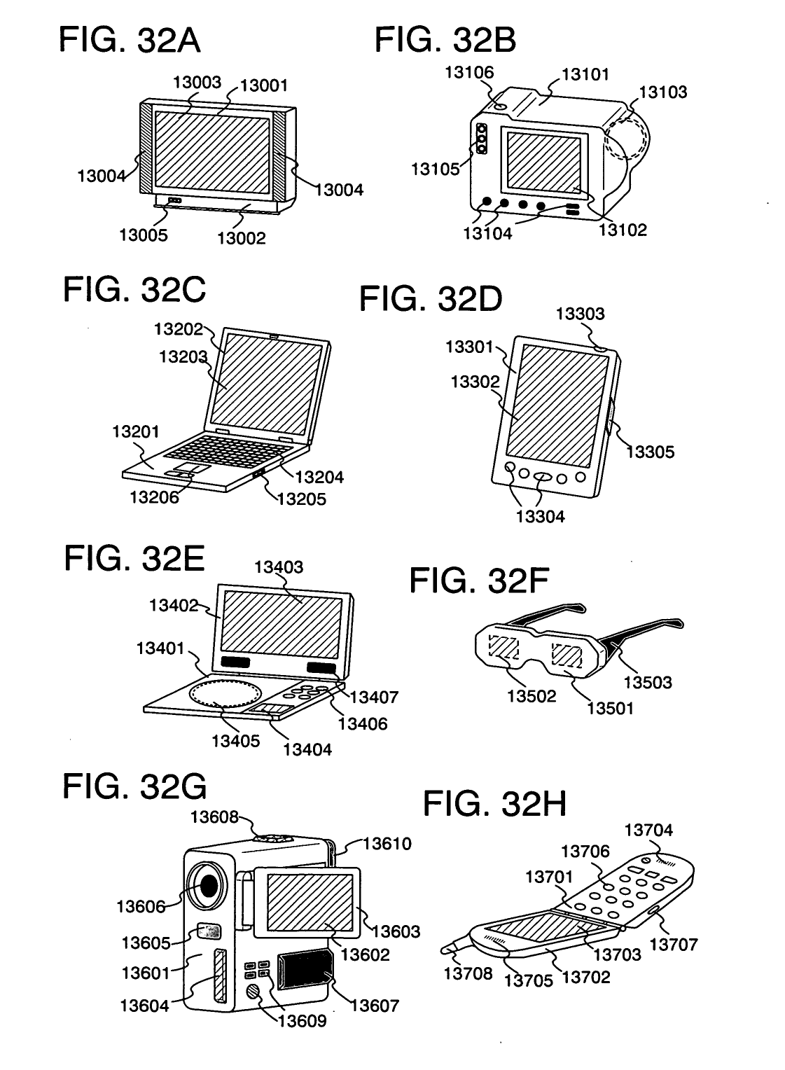

As examples of an electronic apparatus using the invention, there are a video camera, a digital camera, a goggle type display, a navigation system, an audio reproducing device (car audio component stereo, audio component stereo, or the like), a computer, a game machine, a portable information terminal (mobile computer, mobile phone, mobile game machine, an electronic book, or the like), an image reproducing device having a recording medium (specifically, a device for reproducing a recording medium such as a Digital Versatile Disc (DVD) and having a display for displaying the reproduced image), and the like. Specific examples of these electronic apparatuses are shown in FIGS. 32A to 32H.

FIG. 32A is a light emitting device that includes a housing 13001, a supporting base 13002, a display portion 13003, speaker portions 13004, a video input terminal 13005, and the like. The invention can be used for a display device constituting the display portion 13003. Further, according to the invention, a clear image where pseudo contours are reduced can be seen, and the light emitting device shown in FIG. 32A is completed. Since the light emitting device is a self-luminous type, a backlight is not required and a thinner display portion than a liquid crystal display is achieved. It is to be noted that the light emitting device includes all display devices for displaying information such as for a personal computer, receiving television broadcasting, and displaying an advertisement.

FIG. 32B is a digital camera that includes a main body 13101, a display portion 13102, an image receiving portion 13103, operating keys 13104, an external connection port 13105, a shutter 13106, and the like. The invention can be used for a display device constituting the display portion 13102. Further, according to the invention, a clear image where pseudo contours are reduced can be seen, and the digital camera shown in FIG. 32B is completed.

FIG. 32C is a computer that includes a main body 13201, a housing 13202, a display portion 13203, a keyboard 13204, an external connection port 13205, a pointing mouse 13206, and the like. The invention can be used for a display device constituting the display portion 13203. Further, according to the invention, a clear image where pseudo contours are reduced can be seen, and the computer shown in FIG. 32C is completed.

FIG. 32D is a mobile computer that includes a main body 13301, a display portion 13302, a switch 13303, operating keys 13304, an infrared radiation port 13305, and the like. The invention can be used for a display device constituting the display portion 13302. Further, according to the invention, a clear image where pseudo contours are reduced can be seen, and the mobile computer shown in FIG. 32D is completed.

FIG. 32E is a portable image reproducing device provided with a recording medium (specifically, a DVD reproducing device), which includes a main body 13401, a housing 13402, a display portion A 13403, a display portion B 13404, a recording medium (DVD or the like) reading portion 13405, an operating key 13406, a speaker portion 13407, and the like. The display portion A 13403 mainly displays image data, and the display portion B 13404 mainly displays text data. The invention can be used for a display device constituting the display portions A and B 13403 and 13404. Note that an image reproducing device provided with a recording medium includes a home-use game machine and the like. Further, according to the invention, a clear image where pseudo contours are reduced can be seen, and the DVD reproducing device shown in FIG. 32E is completed.

FIG. 32F is a goggle type display that includes a main body 13501, a display portion 13502, and an arm portion 13503. The invention can be used for a display device constituting the display portion 13502. Further, according to the invention, a clear image where pseudo contours are reduced can be seen, and the goggle type display shown in FIG. 32F is completed.

FIG. 32G is a video camera that includes a main body 13601, a display portion 13602, a housing 13603, an external connection port 13604, a remote control receiving portion 13605, an image receiving portion 13606, a battery 13607, an audio inputting portion 13608, operating keys 13609, an eye piece portion 13610, and the like. The invention can be used for a display device constituting the display portion 13602. Further, according to the invention, a clear image where pseudo contours are reduced can be seen, and the video camera shown in FIG. 32G is completed.

FIG. 32H is a mobile phone that includes a main body 13701, a housing 13702, a display portion 13703, an audio inputting portion 13704, an audio outputting portion 13705, an operating key 13706, an external connection port 13707, an antenna 13708, and the like. The invention can be used for a display device constituting the display portion 13703. It is to be noted that the current consumption of the mobile phone can be suppressed by displaying white text on a black background in the display portion 13703. Further, according to the invention, a clear image where pseudo contours are reduced can be seen, and the mobile phone shown in FIG. 32H is completed.

It is to be noted that if the luminance of a light emitting material increases in future, light including outputted image data can be expanded and projected by a lens and the like to be used for a front or rear projector.

Furthermore, the aforementioned electronic apparatuses are becoming to be used for displaying data distributed through a telecommunication line such as Internet and a CATV (cable television system), and in particular for displaying moving image data. A light emitting device is suitable for displaying moving images since the light emitting material has an extremely high response rate.

In a light emitting device, a portion where light is emitted consumes power. Therefore, it is desirable to display data such that the light emitting portion is as small as possible. Accordingly, in the case where the light emitting device is used for a display portion that mainly displays text data, such as a portable information terminal, in particular, a mobile phone or an audio reproducing device, it is desirable to drive so that light emitting portions display text data while non-light emitting portions serve as the background.

As described above, the application range of the invention is so wide that the invention can be applied to electronic apparatuses of all fields. In addition, the electronic apparatuses in this embodiment mode may use a display device having any of the configurations shown in Embodiment Modes 1 to 9.

### BRIEF DESCRIPTION OF THE DRAWINGS

[FIG. 1] A diagram showing a configuration of a driving method of a display device according to the invention.

[FIG. 2] A diagram showing a configuration of a driving method of a display device according to the invention.

[FIG. 3] A diagram showing a configuration of a driving method of a display device according to the invention.

[FIG. 4] A diagram showing a configuration of a driving method of a display device according to the invention.

[FIG. 5] A diagram showing a configuration of a driving method of a display device according to the invention.

[FIG. 6] A diagram showing a configuration of a driving method of a display device according to the invention.

[FIG. 7] A diagram showing a configuration of a driving method of a display device according to the invention.

[FIG. 8] A diagram showing a configuration of a driving method of a display device according to the invention.

[FIG. 9] A diagram showing a configuration of a driving method of a display device according to the invention.

[FIG. 10] A diagram showing a configuration of a driving method of a display device according to the invention.

[FIG. 11] A diagram showing a configuration of a driving method of a display device according to the invention.

[FIG. 12] A diagram showing a configuration of a driving method of a display device according to the invention.

[FIG. 13] A diagram showing a configuration of a driving method of a display device according to the invention.

[FIG. 14] A diagram showing a configuration of a driving method of a display device according to the invention.

[FIG. 15] A diagram showing a configuration of a driving method of a display device according to the invention.

[FIG. 16] A diagram showing a configuration of a display device according to the invention.

[FIG. 17] A diagram showing a configuration of a driving method of a display device according to the invention.

[FIG. 18] A diagram showing a configuration of a display device according to the invention.

[FIG. 19] A diagram showing a configuration of a driving method of a display device according to the invention.

[FIG. 20] A diagram showing a configuration of a driving method of a display device according to the invention.

[FIG. 21] A diagram showing a configuration of a display device according to the invention.

[FIG. 22] A diagram showing a configuration of a display device according to the invention.

[FIG. 23] A diagram showing a configuration of a display device according to the invention.

[FIG. 24] A diagram showing a configuration of a display device according to the invention.

[FIG. 25] A diagram showing a configuration of a display device according to the invention.

[FIG. 26] A diagram showing a configuration of a display device according to the invention.

[FIG. 27] A diagram showing a configuration of a display device according to the invention.

[FIG. 28] A diagram showing an electronic apparatus to which the invention is applied.

[FIGS. 29A to 29B] Diagrams each showing a configuration of a display device according to the invention.

[FIG. 30] A diagram showing an electronic apparatus to which the invention is applied.

[FIG. 31] A diagram showing a configuration of a display device according to the invention.

[FIGS. 32A to 32H] Diagrams each showing an electronic apparatus to which the invention is applied.

[FIG. 33] A diagram showing a configuration of a conventional driving method of a display device.

[FIG. 34] A diagram showing a configuration of a conventional driving method of a display device.

[FIG. 35] A diagram showing a configuration of a conventional driving method of a display device.

1. A driving method of a display device comprising:
dividing one frame into a plurality of subframes for a high-order bit and a plurality of subframes for a low-order bit;
performing almost equally weighting with respect to light emission of the plurality of subframes for the high-order bit; and
performing weighting based on a binary number with respect to light emission of the plurality of subframes for the low-order bit,
wherein a first light is emitted in a first subframe of the plurality of subframes for the high-order bit,
wherein a second light is emitted in one subframe of the plurality of subframes for the low-order bit after emitting the first light, and
wherein a third light is emitted in a second subframe of the plurality of subframes for the high-order bit after emitting the second light.

2. A driving method of a display device comprising:
dividing one frame into a plurality of subframes for a high-order bit and a plurality of subframes for a low-order bit;
performing almost equally weighting with respect to light emission of the plurality of subframes for the high-order bit; and
performing weighting based on a binary number with respect to light emission of the plurality of subframes for the low-order bit,
wherein a first light is emitted in a first subframe of the plurality of subframes for the low-order bit,
wherein a second light is emitted in one subframe of the plurality of subframes for the high-order bit after emitting the first light, and
wherein a third light is emitted in a second subframe of the plurality of subframes for the low-order bit after emitting the second light.

3. A driving method of a display device comprising:
dividing one frame into a plurality of subframes for a high-order bit and a plurality of subframes for a low-order bit;
performing almost equally weighting with respect to light emission of the plurality of subframes for the high-order bit; and
performing weighting based on a binary number with respect to light emission of the plurality of subframes for the low-order bit,
wherein a first light is emitted in a first subframe of the plurality of subframes for the low-order bit,
wherein a second light is emitted in a plurality of subframes of the plurality of subframes for the high-order bit after emitting the first light, and
wherein a third light is emitted in a second subframe of the plurality of subframes for the low-order bit.

4. A driving method of a display device comprising:
dividing one frame into a plurality of subframes for a high-order bit and a plurality of subframes for a low-order bit;
performing almost equally weighting with respect to light emission of the plurality of subframes for the high-order bit; and
performing weighting based on a binary number with respect to light emission of the plurality of subframes for the low-order bit,
wherein a first light is emitted in a first subframe of the plurality of subframes for the high-order bit,
wherein a second light is emitted in a plurality of subframes of the plurality of subframes for the low-order bit after emitting the first light, and
wherein a third light is emitted in a second subframe of the plurality of subframes for the high-order bit.

5. A driving method of a display device comprising:
dividing one frame into a plurality of subframes for a high-order bit and a plurality of subframes for a low-order bit;
performing almost equally weighting with respect to light emission of the plurality of subframes for the high-order bit; and
performing weighting based on a binary number with respect to light emission of the plurality of subframes for the low-order bit,
wherein either the plurality of subframes for the high-order bit or the plurality of subframes for the low-order bit that has a smaller number of bits are selected through one subframe selected from either the plurality of subframes for the high-order bit or the plurality of subframes for the low-order bit that has a larger number of bits.

6. The driving method of a display device according to claim 1, wherein the display device is an EL display.

7. The driving method of a display device according to claim 2, wherein the display device is an EL display.

8. The driving method of a display device according to claim 3, wherein the display device is an EL display.

9. The driving method of a display device according to claim 4, wherein the display device is an EL display.

10. The driving method of a display device according to claim 5, wherein the display device is an EL display.
